(19) United States
(12) Patent Application Publication
(10) Pub. No.: US 2014/0114691 A1
(43) Pub. Date: Apr. 24, 2014

(54) Methods and Systems for the Integrated Collection of Data for Use in Incident Reports and Insurance Claims and to Related Methods of Performing Emergency Responder Cost Recovery

(71) Applicant: InnovaPad, LP, Greenville, SC (US)

(72) Inventor: Vikram Pearce, Greenville, SC (US)

(21) Appl. No.: 14/058,442

(22) Filed: Oct. 21, 2013

Related U.S. Application Data
(60) Provisional application No. 61/717,464, filed on Oct. 23, 2012.
(60) Provisional application No. 61/816,936, filed on Apr. 29, 2013.

(51) Int. Cl. G06Q 40/08

(52) U.S. Cl. CPC G06Q 40/08
USPC 705/4

(57) ABSTRACT

Methods of performing emergency responder cost recovery are provided in which incident data, individual data and insurance data relating to an incident are electronically received from a remote computing device associated with an emergency responder organization. An incident report is automatically generated based on the received data. The incident report is electronically transmitted to the emergency responder organization. An insurance claim is generated based on the received data, and this insurance claim is electronically transmitted to an insurance carrier.

### CROSS-REFERENCE TO RELATED APPLICATIONS

The present application claims priority under 35 U.S.C. §119 to U.S. Provisional Patent Application Ser. No. 61/717,464, filed Oct. 23, 2012 and to U.S. Provisional Patent Application No. 61/816,936, filed Apr. 29, 2013, the entire content of each of which is incorporated herein by reference as if set forth in its entirety herein.

### FIELD OF THE INVENTION

The present invention is directed to cost recovery and, more particularly, to methods and systems that may be used to perform cost recovery for emergency responders.

### BACKGROUND

A relatively new trend is for emergency responder organizations such as fire departments, police departments and emergency medical service (“EMS”) agencies is to charge for at least some of the services that they provide in contrast to the traditional approach where these services were often provided solely at the taxpayers' expense. For example, New York City's fire department has announced that it will be charging motorists a fee for responding to traffic accidents. The decisions to charge for these services is driven partially by a need for emergency responder organizations to seek new revenue streams in an era of stagnant or declining budgets. Additionally, charging for services imposes the costs of responding to the accident on those involved in the accident. Charging for services that are provided by emergency responder organizations is typically referred to as emergency responder “cost recovery.” Cost recovery efforts may provide additional revenue to communities without raising property or personal income taxes.

However, to date, cost recovery programs have exhibited somewhat disappointing results. For example, one city in New York reported that in 2011 it realized a total of $14,000 in cost recovery revenues rather than the $100,000 in cost recovery revenue that had been anticipated. Another city in California realized $40,000 in cost recovery revenue, which was significantly less than the $200,000 in cost recovery revenue that had been expected. Further, emergency responder organizations such as fire departments that implemented cost recovery efforts often found that more time was required at accident scenes for collecting information needed to make cost recovery claims. This extra time removed these organizations from service for other emergencies.

In some cases, the recipient of a bill charging for emergency responder services may have insurance that potentially will reimburse the recipient for all or part of the charge. However, the cost recovery systems that are currently used by emergency responder organizations may require that the emergency responder organization expend significant time and resources above and beyond completing an accident report in order to collect the information necessary to support an insurance claim and to work through the insurance claim process. In order to assist emergency responder organizations in these tasks, third party cost recovery companies have been formed that generate the insurance claims, handle the insurance adjustment, implement collection procedures and perform other administrative activities. However, these third party cost recovery companies are one step removed from the information contained in the official incident report and, in many cases, require the emergency responder organization to provide information after the incident report is completed.

U.S. Pat. No. 8,121,753 is directed to a system and associated method for gathering and submitting data to a third party in response to a vehicle being involved in an accident. In the system of this patent, an information manager stores data regardless of the vehicle being involved in an accident. Next, an event detection manager stores data in response to detecting the vehicle being involved in an accident. Next, the information manager stores state data pertaining to the vehicle's current state. Then an adjacent identifier manager requests, receives and stores data from surrounding vehicles. Next, a report is generated and encrypted, and an encryption and transmission manager stores the report in memory. However, this invention is focused on collecting and using sensor data from sensors that are attached to the vehicles and reporting on the physical circumstances of the accident itself.

United States Patent Publication No. 2009/0106139 discloses a cost recovery billing system for an emergency responder department that includes a first computer based device having cost recovery billing software loaded thereon that is used for billing a responsible party for an at fault incident. The system electronically receives responsible party incident report data from an emergency responder, searches the responsible party incident report data for cost determinative data, manipulates the cost determinative data to provide cost data, and associates the cost data with insurance claim data in order to produce bill data for presentation to an insurance provider. In the system disclosed in this patent publication, the process is initiated in response to a call from the bill recipient to the emergency responder.

There have also been attempts to automate the accident reporting process. One such attempt is disclosed in United States Patent Publication No. 2010/0161491, which is directed to a “computer implemented method for rapidly and securely filing, via wireless means, a consolidated accident report.” This patent publication provides for an electronic accident report that can be completed by both (or multiple) parties to an accident at the accident location. The report can then be transmitted to an interested party.

Further, United States Patent Publication No. 2012/0078662 discloses a device, system, and method for digitally filling out, completing, and transmitting an emergency medical services report form. The computerized emergency medical services report form is designed to mimic the emergency medical services report form that the user is already accustomed to completing during an incident. The user completes the digital form by entering the incident data into the form via a touch screen or keyboard. Because the digital form is essentially identical to the standard paper version of the emergency medical services report form, the users do not require a significant amount of additional training on how to fill out the digital form. However, this application seems to be directed to providing information to a medical facility after the EMS has completed its portion of the infield treatment and the injured party is transferred to a medical facility.

### SUMMARY

Pursuant to embodiments of the present invention, systems and methods are provided for automating and integrating incident reporting and emergency responder cost recovery. These systems and methods may be used to (1) obtain information relating to an incident (e.g., an automobile accident, a house fire, etc.) that is collected by an emergency responder, (2) generate an insurance claim based on the collected incident information, (3) generate incident reports based on the collected information, (4) transmit the incident reports to appropriate receiving agencies, including, but not limited to police, fire, and/or EMS organizations, and (5) process the insurance claims, and otherwise perform emergency responder cost recovery as part of a process that is integrated with the incident reporting processes.

Pursuant to some embodiments of the present invention, methods of performing emergency responder cost recovery are provided in which incident data, individual data and insurance data relating to an incident are electronically received from a remote computing device associated with an emergency responder organization. An incident report is automatically generated based on the received data. The incident report is electronically transmitted to the emergency responder organization. An insurance claim is generated based on the received data, and this insurance claim is electronically transmitted to an insurance carrier.

In some embodiments, the remote computing device may be a portable computing device running a software application that prompts a user to enter the incident data, the individual data and the insurance data. The entered data may include text, pictures, scanned data and/or audio file(s) such as an audio file containing a description of the incident. The incident may be, for example, an automobile accident. In this case, the individual data may include driver data, and the pictures may include pictures taken using a camera on the portable computing device of the insurance card, a driver's license for at least one the drivers involved in the automobile accident, a vehicle registration card, a police report and/or a license plate.

In some embodiments, these methods may further include receiving payment on the insurance claim from the insurance carrier. A portion of the received payment may be provided to the emergency responder organization. The remote computing device and the software application may, in some cases, be provided to the emergency responder organization without any initial charge. In such cases, the cost of the remote computing device and/or the software application may be recovered by reducing the portion of the received insurance payment that is provided to the emergency responder organization.

In some embodiments, the received data may include captions for at least some of the pictures that are included in the received data. Additionally, a recoverable cost listing may be generated and the incident report and the recoverable cost listing may be automatically combined to generate the insurance claim. Insurance claim status information may be transmitted to the emergency responder organization. Additionally, a reminder may be automatically transmitted to the emergency responder organization to forward a copy of an accident report.

Pursuant to further embodiments of the present invention, methods of collecting data at a scene of an accident for use in generating an accident report and an insurance claim are provided. Pursuant to these methods, at the scene of the accident, a portable computing device that runs a cost recovery software application is used to collect data relating to the accident. This collected data may include a description of the accident, pictures of the accident scene taken using a camera on the portable computing device, additional pictures taken using the camera on the portable computing device, the additional pictures including pictures of at least one of a driver's license of a driver involved in the accident, a police report relating to the accident, a license plate of a vehicle involved in the accident, a registration card of a vehicle involved in the accident, and an insurance card, and scanned data obtained by using a scanning capability on the portable computing device to scan a document. The collected data is electronically transmitted to a remote server associated with a third party service provider for use in filing a cost recovery insurance claim. An accident report is electronically received from the third party service provider for use in preparing an official accident report.

In some embodiments, the description of the accident may comprise recorded audio data. Captions for at least some of the pictures and/or the additional pictures may also be entered using the software application and the portable computing device. The collected data may be deleted from the portable computing device in response to receiving an indication that the collected data has been successfully transmitted to the third party service provider. The collected data may include a picture of a police report relating to the accident or identification of a police department present at the scene of the accident and the name of a police officer present or an identification number associated with the police report relating to the accident.

Pursuant to still further embodiments of the present invention, systems for generating incident reports and insurance claims for emergency responder cost recovery are provided which include a server having a computer readable medium and a processor, the server in electronic communications with a remote computing device, an insurance carrier and an emergency responder organization. These system further include a set of computer readable instructions stored in the computer readable medium that, when executed by the processor, receive incident data, individual data and insurance data from the remote computing device, receive insurance information from an insurance carrier, generate insurance claims, generate at least one incident report based on the received incident data, individual data, insurance data and insurance information, transmit the incident report to the emergency responder organization, transmit the insurance claim to the insurance carrier, receive insurance claim status information, and provide the insurance claim status information to the emergency responder organization.

### BRIEF DESCRIPTION OF THE DRAWINGS

The following description of the invention will be better understood by reference to the following drawings that are incorporated and made part of the written specification:

FIG. 1 is a schematic block diagram illustrating various reports and documents that may be generated when emergency responder organizations respond to an incident.

FIG. 2 is a schematic block diagram illustrating a system for collecting data involving an incident that is used for both preparing reports and filing insurance claims according to certain embodiments of the present invention.

FIG. 3 is a schematic block diagram illustrating a system for collecting and processing incident data for report preparation and generating insurance claims according to certain embodiments of the present invention.

FIGS. 4A-4R are example screen shots illustrating data entry screens that may be presented to a user of a mobile computing device that is collecting incident data.

FIGS. 5A-C illustrate an example incident report according to embodiments of the present invention that is delivered via e-mail.

FIGS. 6A-6D are example screen shots illustrating data entry screens that may be presented to a cost recovery agent during the initial processing of a cost recovery insurance claim.

FIG. 7 illustrates an example internal insurance claim report according to certain embodiments of the present invention.

FIGS. 8A-8B illustrate an example insurance claim that may be generated using the systems and methods according to embodiments of the present invention.

FIGS. 9A-9C are example screen shots illustrating data entry screens that a cost recovery agent may use to enter cost recovery data that may be used in preparing an insurance claim.

FIG. 10 is a schematic block diagram illustrating a system for collecting and processing incident data for report preparation and generating insurance claims according to further embodiments of the present invention.

FIG. 11 is a flow chart of a method of according to certain embodiments of the present invention.

FIG. 12 is a schematic block diagram of a server according to embodiments of the present invention that may be used to prepare incident reports and perform emergency responder cost recovery.

FIG. 13 is a schematic diagram illustrating the various sub-programs of a cost recovery software application according to embodiments of the present invention.

### DETAILED DESCRIPTION

Pursuant to embodiments of the present invention, methods, systems and computer program products are provided which may allow emergency responder organizations (also referred to as “first responders”) such as police departments, fire departments and EMS agencies to reduce clerical work and increase their efficiency while providing new sources of revenue for municipalities.

In some embodiments, emergency responders (e.g., a fire fighter, a police officer or other employee or agent of an emergency responder organization) may use a portable computing device such as a smart phone, iPad®, iPhone®, netbook computer, laptop computer, etc. collect data at the scene of an automobile accident or other incident. A software application may run on the portable computing device that may prompt a user (i.e., an emergency responder such as a police officer, a fire fighter, an ambulance operator, etc.) to electronically collect data relating to the incident along with data that may be needed for filing an insurance claim relating thereto. The portable (mobile) nature of the computing device may allow the emergency responder to collect and record the data while outside of their emergency response vehicle, which may facilitate data collection and allow the collection of more accurate data. The software application may prompt the user to ensure that all necessary data is in fact collected. The portable computing device may be used to collect multimedia data such as pictures and/or video clips and, in some embodiments, may automatically integrate such multimedia data into a composite data structure. Additionally, some of the collected data may be entered using a microphone on the portable computing device (to input, for example, voice data), using an optical character recognition capability of the portable computing device and/or by using a scanning capability on the portable computing device to scan a computer readable bar code or other data containing pattern. Once collected, the data may be electronically transmitted to another computing device such as, for example, a cloud server. In some embodiments, the collected data can only be transmitted after all of the required data fields have been populated to ensure that full data collection occurs at the scene of the incident. Thus, the methods and systems according to embodiments of the present invention may provide for easier and more accurate collection of data at the scene of an incident such as an automobile accident.

The data may be collected at the scene of the incident in an integrated fashion so that the collected data may be used in the preparation of multiple different types of documents and reports such as, for example, official accident reports and insurance claims and associated documentation. The cloud server or other computing device that the collected data is electronically transmitted to may be associated with a third party cost recovery entity. The collected data may be automatically deleted from the portable computing device once it has been received by the third party cost recovery entity, which may facilitate compliance with various requirements of the Health Insurance Portability and Accountability Act (“HIPPA”). The third party cost recovery entity may electronically transmit the collected data to the emergency responder organization, and may provide the collected data to the emergency responder organization in an organized format that may make it easier for the emergency responder organization to use the data to prepare official reports regarding the incident such as, for example, a National Fire Incident Reporting System (“NFIRS”) report. The third party cost recovery entity may use the received data to file an insurance claim with an insurance carrier of an individual or entity involved in the incident to recover costs expended by the emergency responder organization in responding to the incident. Moreover, the insurance claim process may be at least partly automated according to embodiments of the present invention to more efficiently process insurance claims.

The methods and systems according to embodiments of the present invention may be more cost effective than traditional cost recovery approaches. When emergency responder organizations attempt to perform cost recovery, they often struggle to collect the necessary information, and may find it difficult to navigate the insurance claim and adjustment processes, which are outside of their core areas of competence. This may result in significant lost time and may make cost recovery not worth the effort. Moreover, prior attempts at using third party cost recovery firms have also not been particularly successful because the third party entities are one step removed from the data collection process and may struggle to obtain all of the information that they need to file and process insurance claims. According to embodiments of the present invention, emergency responders are provided with a tool that may allow the emergency responder to more efficiently collect data from the scene of an incident that must be collected for official reporting purposes and, at the same time, collect additional information that is necessary in order to efficiently prepare, file and process insurance claims. This information is seamlessly provided to agents of a third party cost recovery provider who may specialize in filing and prosecuting insurance claims, and hence can typically do so in less time and with a better success rate than a typical emergency responder, and without forcing emergency responders to spend excessive amounts of time processing insurance claims in lieu of responding to emergencies.

Finally, it will also be appreciated that the methods and systems according to certain embodiments of the present invention may provide an essentially risk-free option for fire departments and other emergency responder organizations since it allows them to file insurance claims without any upfront equipment costs and without added administrative paperwork, report generation, claim tracking and the like. The methods and systems according to embodiments of the present invention may also provide emergency responders with a tool that may increase their efficiency in collecting data at incident scenes for official reports. In some cases, the emergency responder may simply collect a percentage of the insurance claim proceeds, with the third party cost recovery entity collecting the remainder of the insurance proceeds that are paid on each claim. This cost recovery arrangement essentially eliminates the financial risk to the emergency responder organization. Thus, the methods and systems according to embodiments of the present invention may allow for greatly expanded emergency responder cost recovery efforts that provide much needed revenue to emergency responder agencies.

The present invention will now be discussed in further detail with reference to the attached drawings, in which illustrative embodiments are shown.

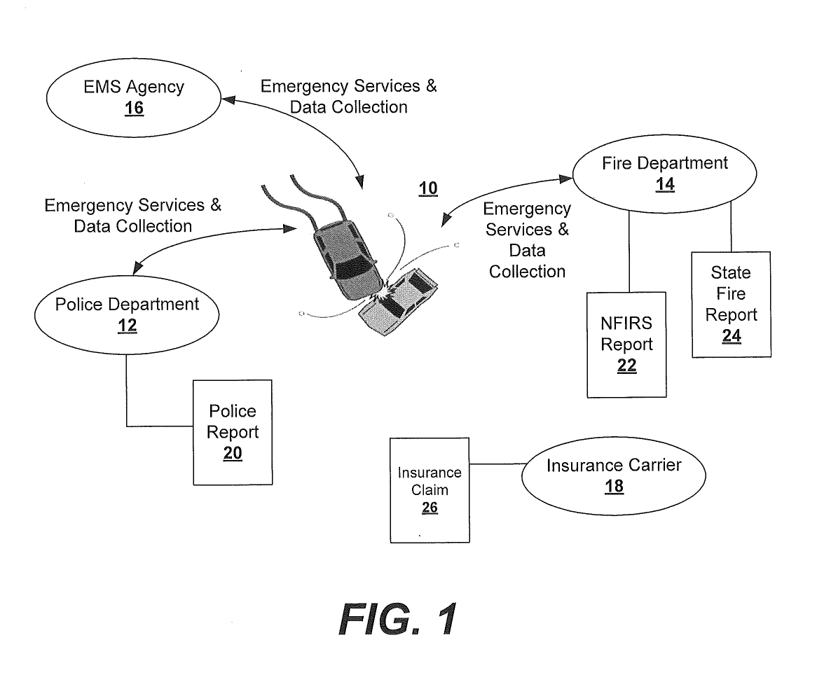

FIG. 1 is a schematic block diagram illustrating various reports and documents that are routinely generated when emergency responder organizations respond to an incident. With reference to FIG. 1, an incident such as, for example an automobile accident, may occur as shown at 10. In response to the accident 10, one or more emergency responder organizations such as a police department 12, a fire department 14, and/or an EMS agency 16 may be dispatched to the scene of the accident 10. Once arriving at the accident scene 10, emergency responders from the organizations 12, 14, 16 may perform various services including extracting individuals involved in the accident from the vehicles involved, providing medical evaluation and emergency medical care, cleaning-up the accident site including arranging for removal of the damaged vehicles and the cleaning of debris from the roadway, directing traffic around the accident, hazardous material handling and clean-up, if necessary, and other various services.

In most municipalities, the responding police officers must fill out police reports 20 for each accident or other incident that document the scene of the incident, the actions taken, and the individuals and property involved. These police reports 20 typically have a standardized report, but this format varies from state-to-state and even from department-to-department. For example, the highway patrol may use a different accident report form than the city police department or the county sheriff. In some jurisdictions, the police reports 20 have a standardized format statewide. In any event, the police reports 20 are typically filled out in paper format and are typically regulated by state laws.

Fire departments 14 that respond to accidents and other incidents (e.g., house fires, hazardous material clean-up, etc.) also complete report forms 22 with respect to each incident they respond to. These reports 22 typically have to comply with the requirements of the National Fire Incident Reporting System (“NFIRS”) that has been established by the Department of Homeland Security, the Federal Emergency Management Agency and the U.S. Fire Administration, Additionally, in some jurisdictions, separate state or county level incident/accident reports 24 must also be completed and filed with the appropriate agencies. Unfortunately, the police and fire reporting systems are not integrated, and the police reports 20 and fire reports 22, 24 have no common report format or structure.

Additionally, if emergency responder cost recovery is to be performed, additional information may need to be collected at the scene of the accident that will be required for any cost recovery insurance claim 26 that is filed with an insurance carrier 18. For example, to file an insurance claim 26, information such as the insurance carrier and policy number of one or more of the individuals (or vehicles) involved in the accident must be known. As another example, in order to recover costs for supplies used in cleaning up the accident and/or equipment that was damaged in responding to the accident, it generally is necessary to track the use of supplies and the damage to equipment. As yet another example, in order to perform cost recovery for medical services that are rendered by the emergency responders at the accident scene, it is necessary to collect data regarding the medical services that were performed and the identities of the individuals who received these medical services.

Pursuant to embodiments of the present invention, an emergency responder such as, for example, a fire fighter may collect data relating to an accident or other incident at the scene of the accident using a portable computing device such as a smart phone (e.g., an iPhone®), a tablet computer (e.g., an iPad®), a portable computer (e.g., a netbook computer) or the like. A software application including computer readable instructions may be installed on the portable computing device. When this software application is executed by a processor of the portable computing device, it may perform various of the functionality described below. The software application may provide a user interface that may allow the emergency responder to quickly and easily collect all of the information (data) at the accident scene 10 that is necessary for preparing various reports and documents such as NFIRS accident reports 22, other state level accident and incident reports 24, and insurance claims 26 and supporting documentation.

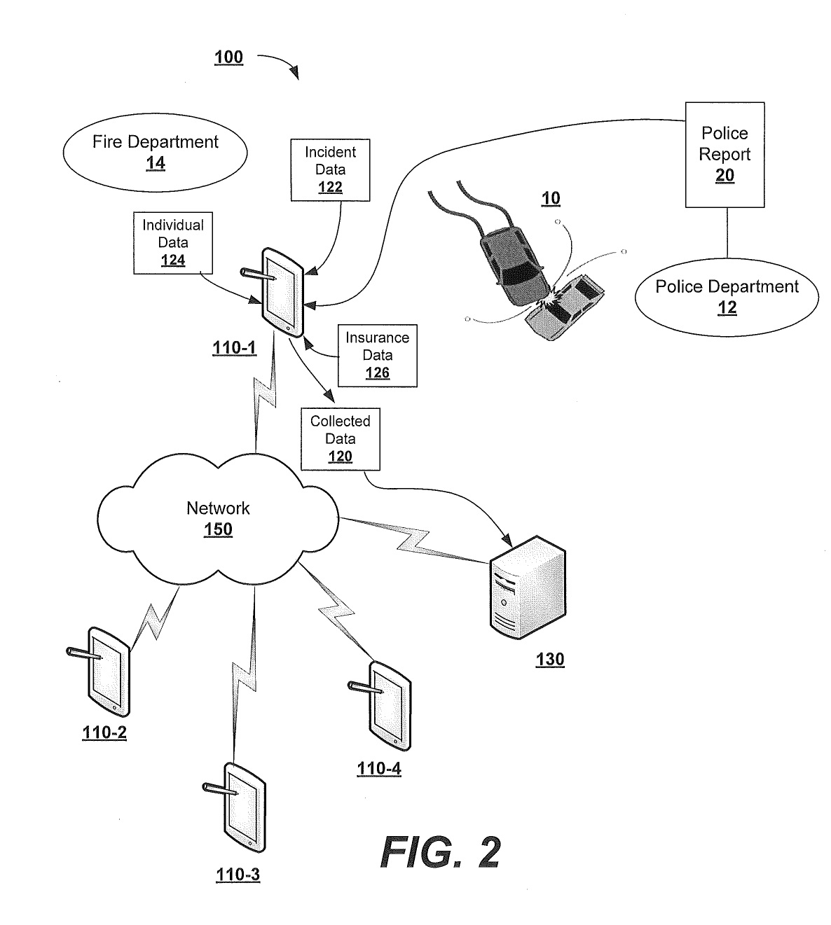

FIG. 2 is a schematic block diagram illustrating a system 100 for collecting data involving an incident that may be used for both preparing reports and filing insurance claims 26 according to certain embodiments of the present invention. As shown in FIG. 2, the system 100 includes a plurality of portable computing devices 110 (labeled 1104 through 110-4 in FIG. 2), a cost recovery server 130 and one or more communications networks that are collectively illustrated in FIG. 2 as a network 150. For purposes of the description herein, the cost recovery server 130 is described as being a single device. However, it will be appreciated that a plurality of devices may together perform the functionality of the cost recovery server 130 that is described below such as, for example, one or more servers or other computing processing devices, one or more memory storage units, electronic communications equipment, etc.

As noted above, the portable computing devices 110 may comprise any appropriate portable computing device such as a smart phone (e.g., an iPhone®), a tablet computer (e.g., an iPad®), a portable computer (e.g., a netbook or laptop computer) or the like. In some embodiments, a software application 112 may be installed on each portable computing device 110. The software application 112 may include computer readable instructions that are executed by a processor of the portable computing device 110. In particular, the software application 112 may create a user interface on the portable computing device 110 that provides a series of “screens” and instructions to a user of the portable computing device 110 that prompt the user to collect various data relating to the accident/incident using various functionality of the portable computing device 110. The user may be, for example, an emergency responder such as a fire fighter. The software application 112 may prompt the emergency responder to collect all of the information (data) at the accident scene that is necessary for preparing various reports and documents such as NFIRS accident reports 22, other state level accident and incident reports 24, and insurance claims 26 and supporting documentation.

As is shown in FIG. 2, the information that is collected using, for example, portable computing device 110-1 may include incident data 122 such as the date and time of the incident (which, in this example is assumed to be an automobile accident 10), the physical location of the accident (e.g., a street address or coordinates), pictures or videos of the accident scene and the damage to the vehicles or other objects, identification of anyone deemed at fault in the incident/accident, a description of the incident, etc. The portable computing device 110-1 may also be used to collect data regarding the persons involved in the incident/accident (referred to herein as “individual data” 124) such as their names, addresses, ages, sex, etc. The portable computing device 110-1 may also be used to collect insurance data 126, which is data that may be necessary for the preparation and prosecution of a cost recovery insurance claim 26. The insurance data 126 may include, for example, the name of the insurance carrier 18 of the at-fault individual(s), insurance policy numbers, vehicle registration numbers, the police report 20 (which may be necessary to prove that the insured was the “at-fault” driver and hence monetarily responsible for payment of the emergency responder fees), etc. The incident data 122, the individual data 124, the insurance data 126 and any other data collected on the portable computing device 110-1 at the scene of the incident is collectively referred to herein as the collected data 120.

As is further shown in FIG. 2, the collected data 120 is electronically transmitted to the cost recovery server 130 over the communications network 150. The portable computing device 110 may have cellular connectivity in some embodiments. If so, the collected data 120 may be entered and uploaded to the cost recovery server 130 from the accident scene 10. In other embodiments, the portable computing device 110 may not have cellular capabilities, but may be WiFi enabled. In such embodiments, the collected data 120 may be uploaded to the cost recovery server 130 when the portable computing device 110 connects to a wireless network. In still other embodiments, the portable computing device 110 may not have any wireless communications capabilities. In such embodiments, the collected data 120 may be electronically transmitted to the cost recovery server 130 by transferring the incident data to another wireless-capable device or by providing a hardwire connection between the portable computing device 110 and a communication network such as a Local Area Network at the fire department 14.

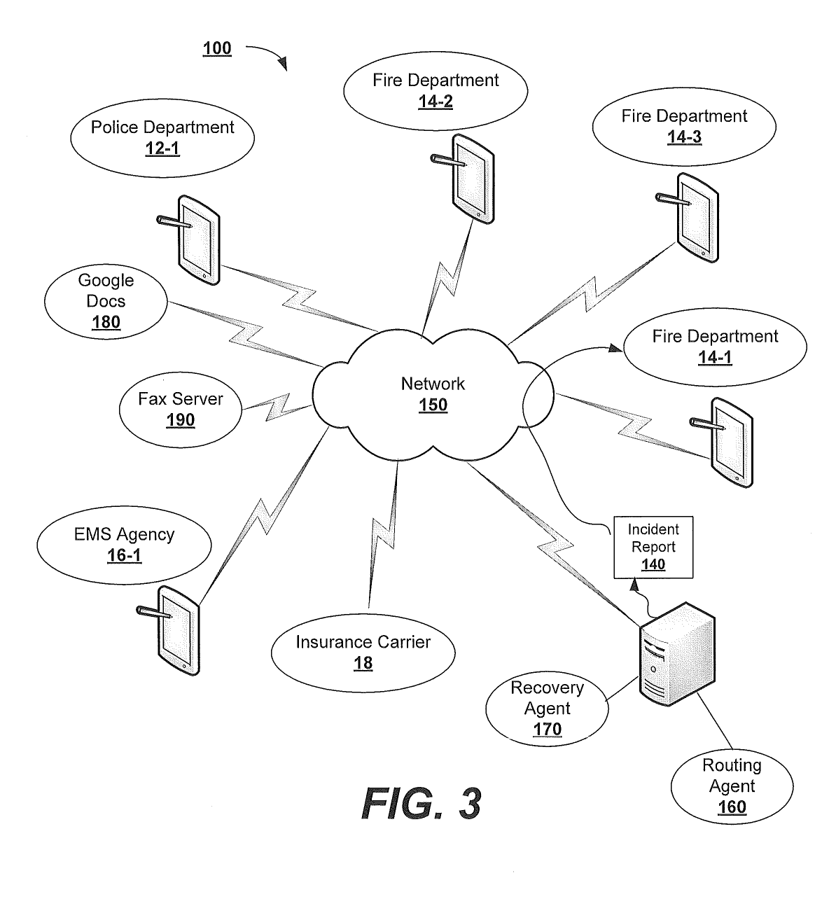

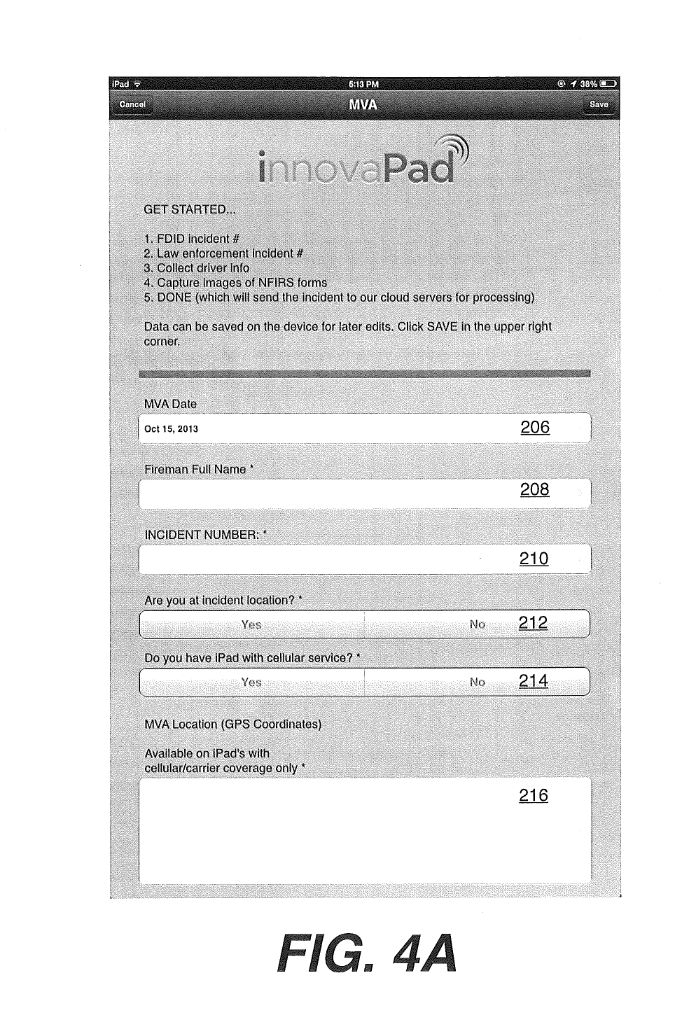

FIG. 3 is a schematic block diagram illustrating how the system 100 of FIG. 2 may be used to process the collected data 120 in order to facilitate the preparation of incident reports such as the fire department reports 22, 24 and to generate insurance claims 26.

As discussed above, each time an emergency responder responds to an accident or other incident, they will collect data 120 relating to the incident at issue on their portable computing device 110. Typically, a single portable computing device 110 will be provided per fire truck or other emergency responder vehicle. The software application 112 that runs on the portable computing device 110 will prompt the emergency responder who is responsible for collecting the data on the portable computing device 110 (the user) to collect all of the information that is necessary for preparation of the various reports and documents by presenting the emergency responder with a series of “screens” (i.e., displays of information on an electronic display screen of the portable computing device 110) that have input fields, pull-down menus, buttons and the like which the emergency responder may use to input the required data. These screens may also have instructions for collecting other types of data (pictures, recordings, optical character recognition derived data, scanned data, etc.) using various input mechanisms provided on the portable computing device 110. Once all of the collected data 120 has been collected/entered into the portable computing device 110, the software application 112 may prompt the emergency responder to save the collected data 120 and/or to electronically transmit it to the cost recovery server 130 (assuming that the portable computing device 110 has communications connectivity). If the emergency responder attempts to save or transmit the collected data 120 before data has been entered into a required data field, a message may be displayed on the display of the portable computing device 110 prompting the emergency responder to collect the missing data to ensure that all necessary data is collected at the accident scene 10.

In some embodiments, once all of the required data 120 has been collected and the user has requested that the collected data 120 be saved, the software application 112 may automatically transmit the collected data 120 to the cost recovery server 130 the next time that the portable computing device 110 is turned on and is in communication with the cost recovery server 130 over the network 150. The cost recovery server 130 may have a computer readable medium that includes computer readable instructions running thereon such as, for example, a cost recovery software application 132. Once the cost recovery server 130 notifies the portable computing device 110 that the collected data 120 for a particular incident has been successfully uploaded, the software application 132 may automatically instruct the portable computing device 110 to delete the collected data 120 from the portable computing device 110. It will be appreciated that the electronic communications between the portable computing device 110 and the cost recovery server 130 can be real-time, batch, wired or wireless.

Once the collected data 120 for accident 10 has been uploaded to the cost recovery server 130, the cost recovery server 130 may, for example, use the cost recovery software application 132 to automatically generate an incident report 140. The incident report 140 may be jurisdiction specific so that it includes all of the information necessary for the reporting requirements of the emergency responder organization that forwarded the collected data 120. The format requirements may, for example, be stored in a data store of the cost recovery server 130 or obtained by the cost recovery server 130 by communicating with another database containing the relevant formatting information. The cost recovery server 130 may automatically transmit the incident report 140 to the emergency responder organization that forwarded the collected data 120 for the incident at issue. The incident report 140 may additionally (or alternatively) be printed or otherwise converted into a physical format for transmission and/or storage. In some embodiments, the cost recovery server 130 may automatically send an e-mail containing the incident report 140 to, for example, the fire fighter who collected the data 120. The fire fighter may then use the incident report 140 to fill out the NFIRS report 22 and any required state or county level report 24. The incident report 140 may be embedded in the body of the e-mail, and the fire fighter may select (e.g., by a mouse click) pictures, audio files and the like, or hyperlinks thereto that are embedded in the e-mail in order to download such materials (or higher quality/resolution copies of these materials) from the cost recovery server 130. The incident report 140 may also be sent to other individuals associated with the emergency responder organization (e.g., the fire chief) by e-mail or other electronic means.

While police departments typically fill out and complete a police report at the scene of each accident or incident, fire departments typically do not fill out the NFIRS report 22 at the scene of the incident, but instead collect the data necessary to complete this report at the scene of the incident and then fill out the actual report at a later time. As such, the NFIRS report 22 is typically not available when data collection occurs at the scene of the accident 10. However, for purposes of cost recovery, and particularly for purposes of filing cost recovery insurance claims, it may be important to have the NFIRS report 22 and present it to the insurance carrier 18 as part of the insurance claim documentation.

In order to obtain a copy of the NFIRS report 22 for each incident, the system 100 may send reminders to the emergency responder organization at, for example, predetermined timeframes after each incident requesting that the emergency responder organization forward the NFIRS report 22 to, for example, the cost recovery server 130. These reminders may be generated and sent automatically by any convenient means such as, for example, one or more e-mails that are sent to the fire chief and/or the emergency responder who collected the data 120 regarding the incident at issue.

Upon receipt of the collected data 120 for a new incident (e.g., for an automobile accident), the cost recovery server 130 may automatically send an electronic message to an agent to initiate the cost recovery process. In some cases, the agent may be a “routing” agent 160 who simply assigns incidents to cost recovery agents 170. In other cases, the cost recovery server 130 may send the electronic message directly to a cost recovery agent 170. Here, “sending” a message “to” these agents refers to sending an e-mail, text message or other electronic communication to an electronic device associated with the agent. Regardless of whether or not a routing agent 160 is involved, the incident report 140 may ultimately be provided to the cost recovery agent 170, who is responsible for initiating the insurance claim process.

The cost recovery agent 170 may review the incident report 140 and determine if one or more of the individuals involved in the incident were designated as being “at fault.” If so, the cost recovery agent 170 may determine from the incident report 140 the insurance carrier 18, if any, that insures the at fault individual and may be able to determine other information such as the insurance agent, the insurance policy number, insurance carrier 18 contact information (phone numbers, facsimile numbers, e-mail addresses), etc. The cost recovery agent 170 may use this information to contact the insurance carrier 18 to notify them that an insurance claim 26 is going to be filed, and to receive the claim number that the insurance carrier 18 will be assigning to this claim. The cost recovery agent 170 may also receive any necessary insurance information from the insurance carrier that was not included in the incident report 140. The cost recovery agent 170 may the use the incident report 140 and/or the NFIRS report 22 (once received from the fire department 14) to fill out the appropriate insurance claim form 26.

In some embodiments, the insurance data 126 that is included in collected data 120 and presented in the incident report 140 may be verified before the insurance claim form 26 is submitted to the insurance carrier 18. This verification may be done manually by the cost recovery agent 170 or may be electronically submitted to the insurance carrier 18 for electronic verification against the insurance carrier's claim system and/or database. Once the insurance data 126 is verified, the insurance claim 26 can be electronically transmitted to the insurance carrier 18 for processing and adjusting. The insurance claim 26 may include an invoice generated using the collected data 120 and from additional cost recovery information (e.g., a schedule of charges, supply and equipment costs, etc. for the particular emergency responder organization that submitted the collected data 120) that may be stored on, for example, the cost recovery server 130 or in databases that can be accessed by the cost recovery server 130.

The insurance claim 26 may include information detailing the emergency responder organization costs that the insurer carrier 18 is being asked to reimburse. These costs may include for example, costs of having fire trucks, ambulances and/or fire fighters present at the scene of the accident, costs of equipment damaged during the response, fuel costs for travelling to the accident scene, supply costs for supplies expended at the scene, etc. The data necessary to determine these costs is either (1) collected at the scene of the accident on the portable computing device 110 (e.g., the supplies used, the number of trucks responding to the incident, the alarm time and end time for the incident response, etc.) and transmitted to the cost recovery server 130 as part of the other collected data 120 or provided to the cost recovery company separately (e.g., a schedule of costs charged for various supplies, for the use of each truck for a specified period of time, etc.).

One or more software applications may be used to implement the systems and methods according to embodiments of the present invention. These software applications may include a software application that runs on each of the portable computing devices 110 and a software application that runs on the cost recovery server 130. In some embodiments, the same software application may be used on both the portable computing devices 110 and the cost recovery server, although only portions of the software application may be implemented (or available) on the portable computing devices 110.

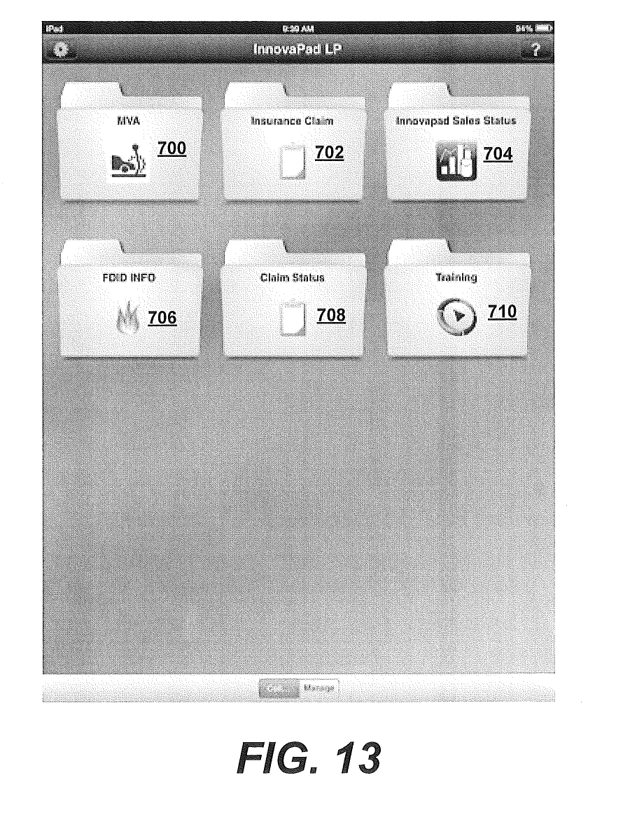

As shown in FIG. 13, in one embodiment, the software application 132 may include six functional sub-programs, namely an MVA sub-program 700, an Insurance Claim sub-program 702, a Sales Status sub-program 704, an FDID Information sub-program 706, a Claim Status sub-program 708, and a Training sub-program 710.

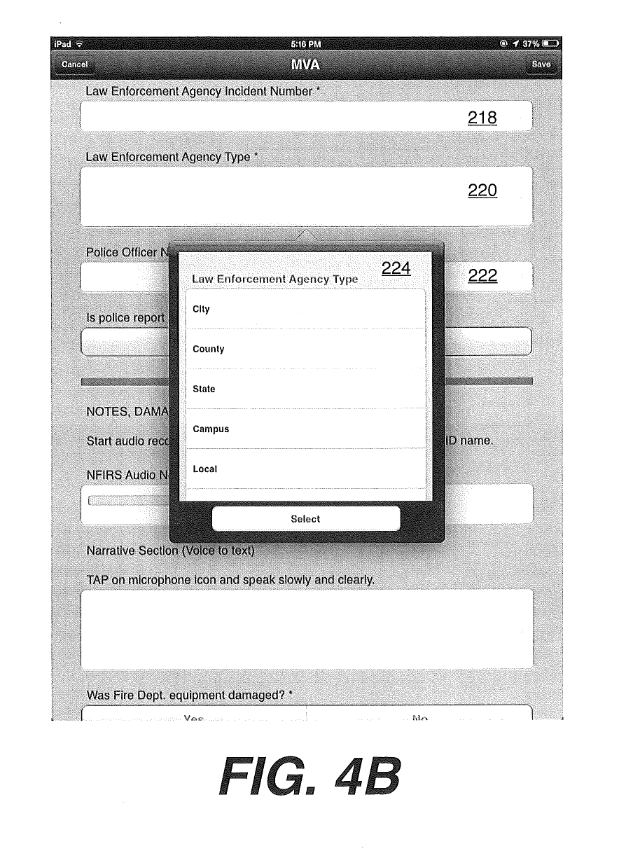

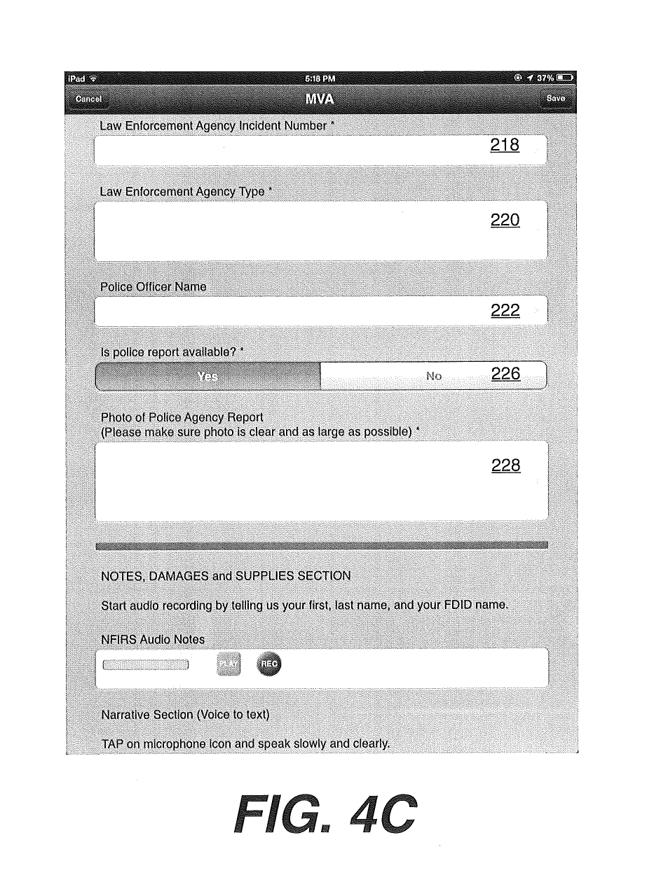

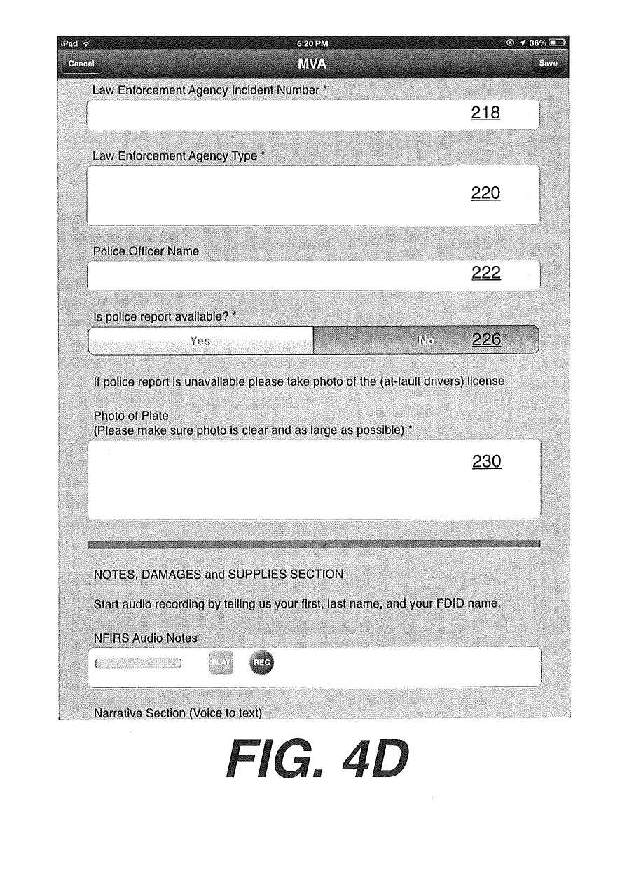

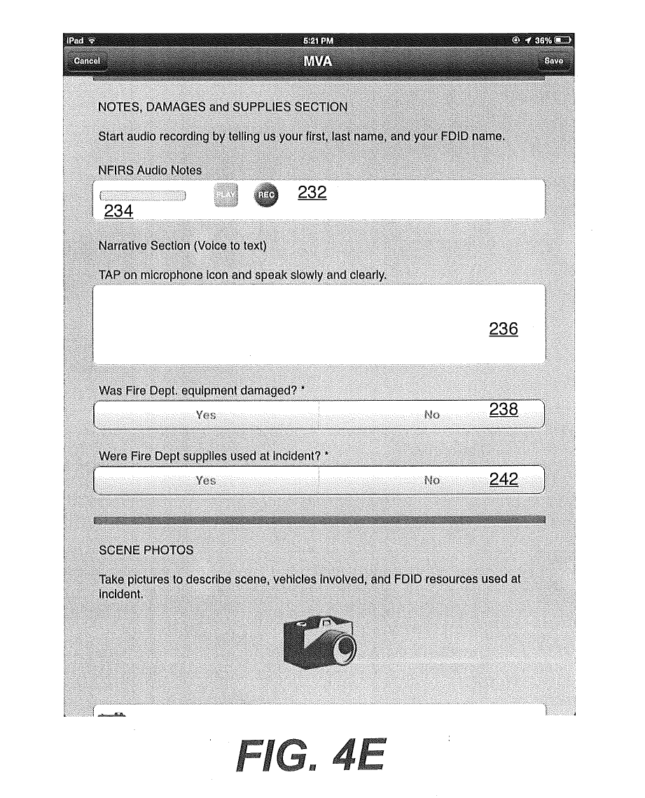

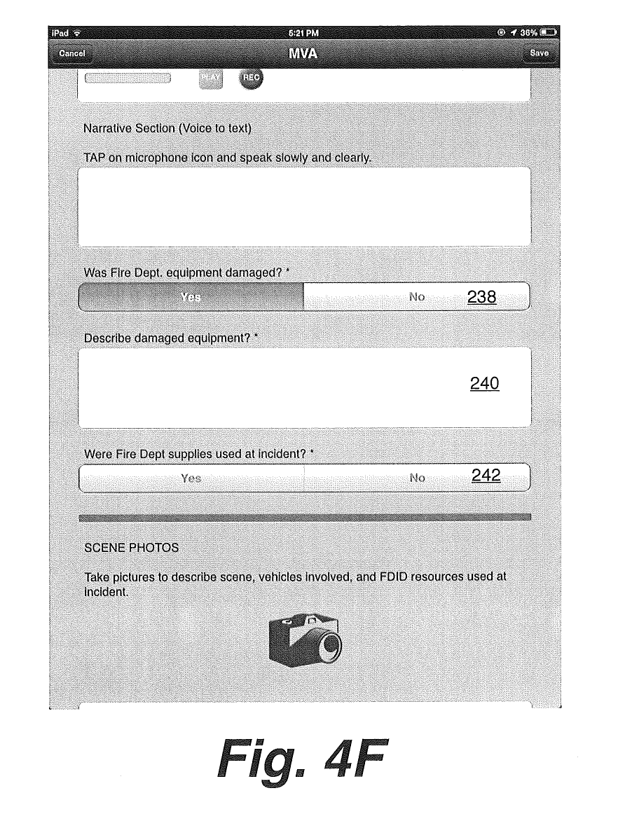

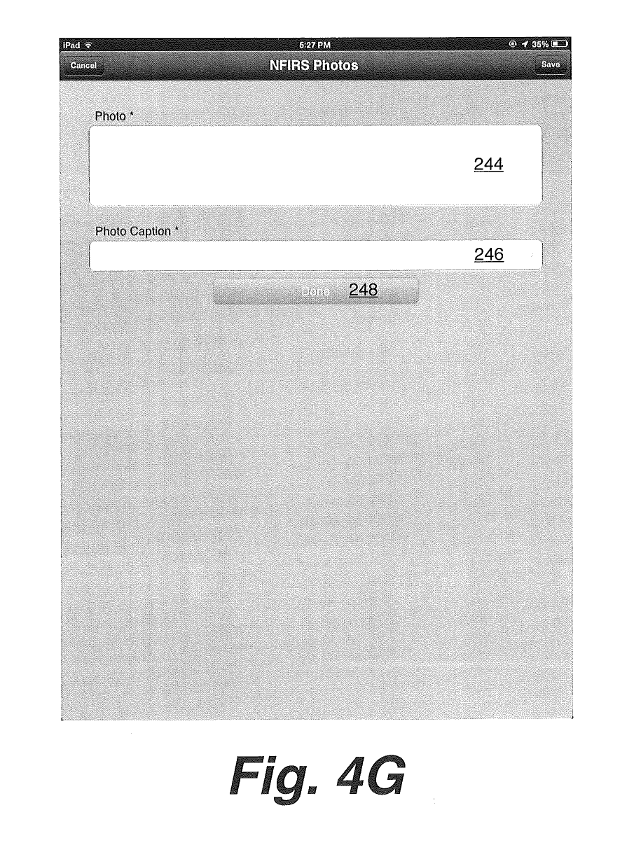

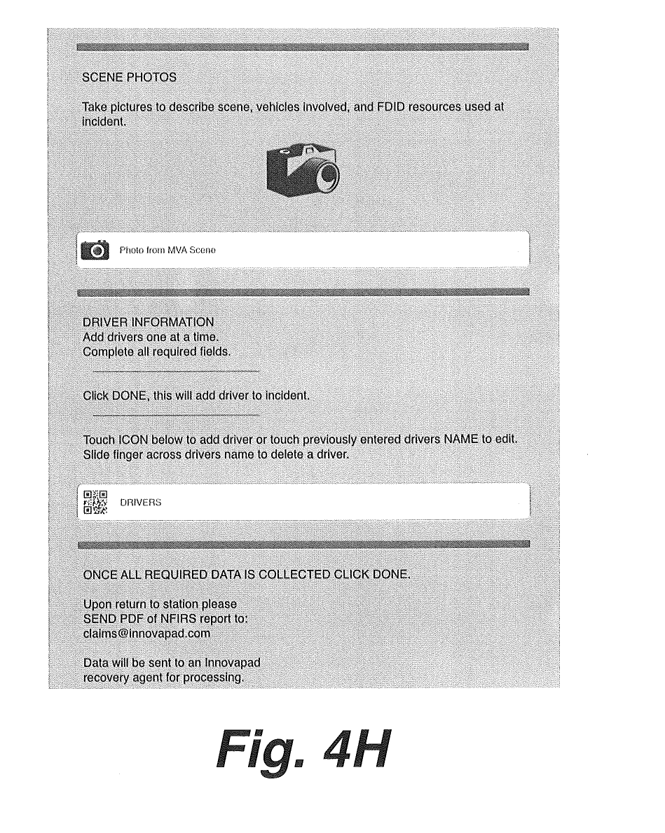

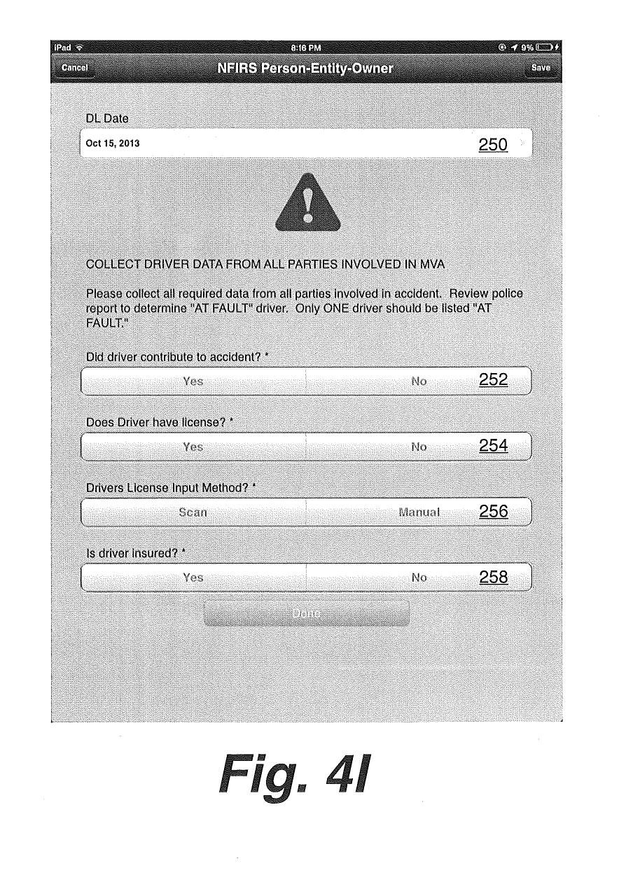

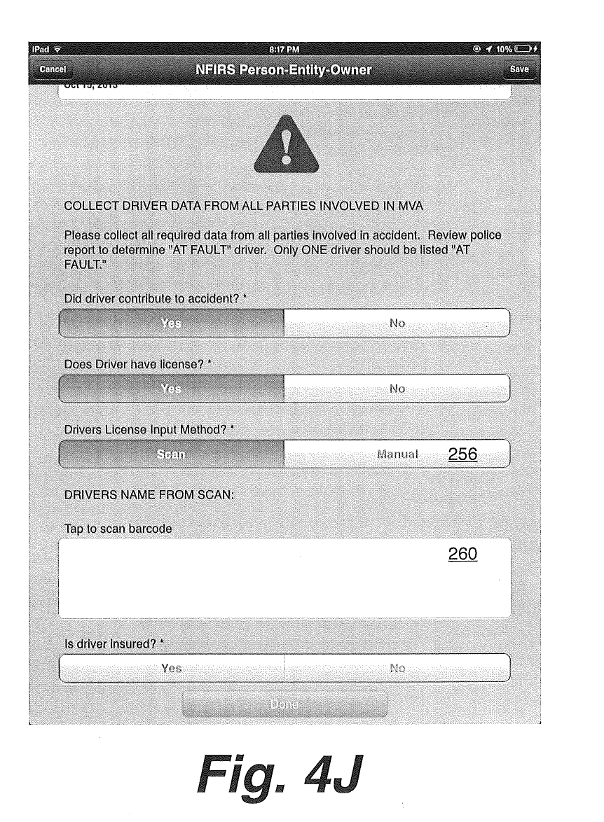

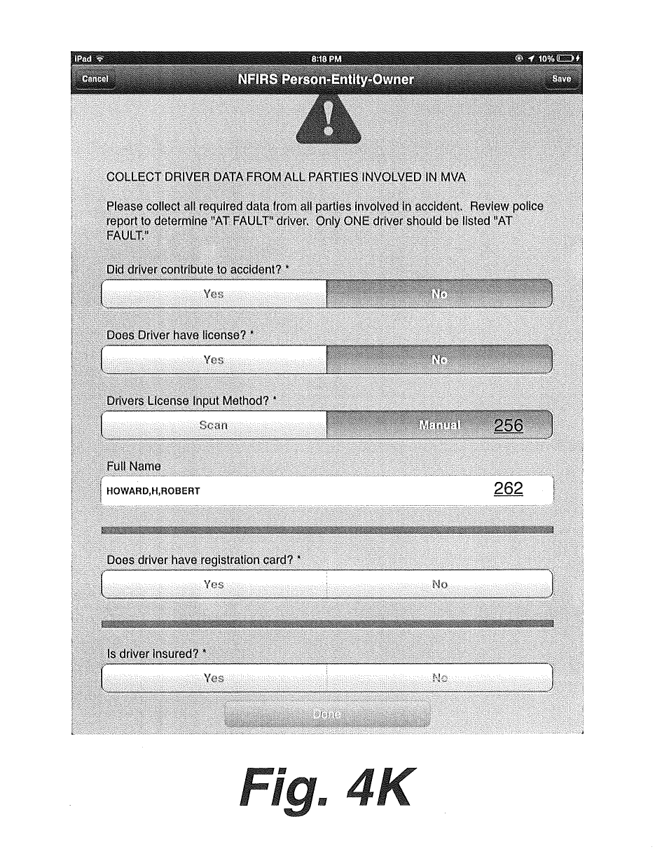

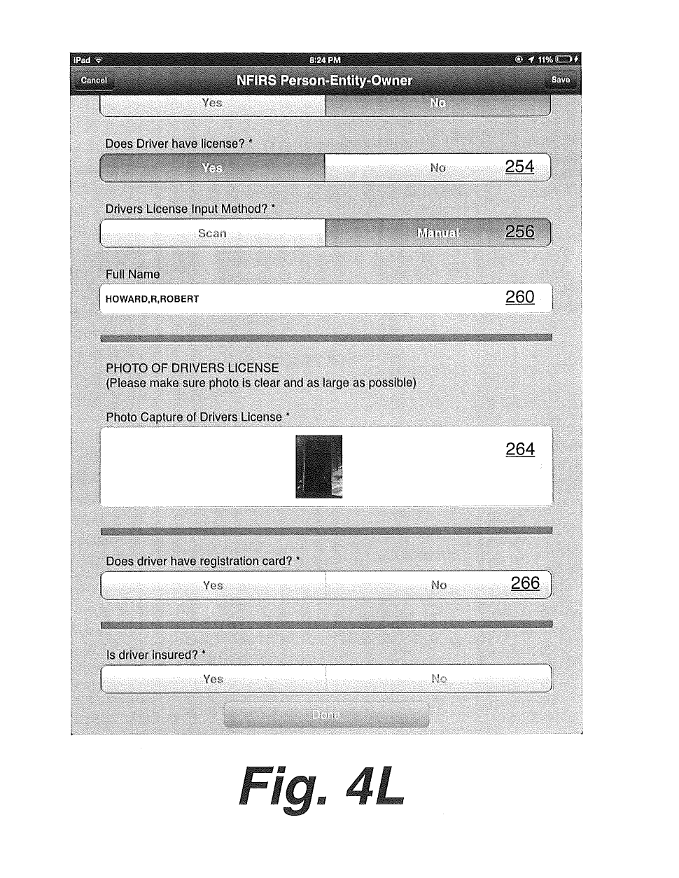

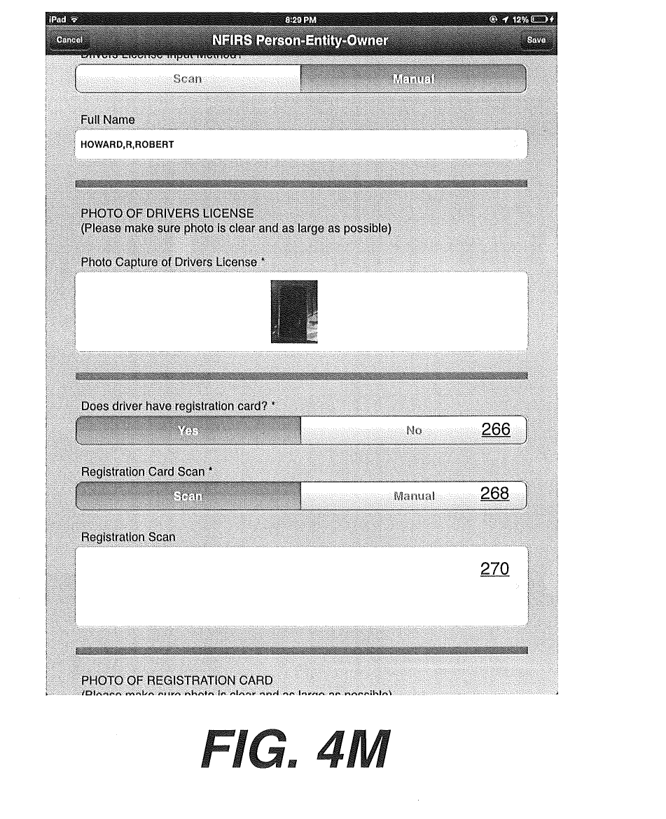

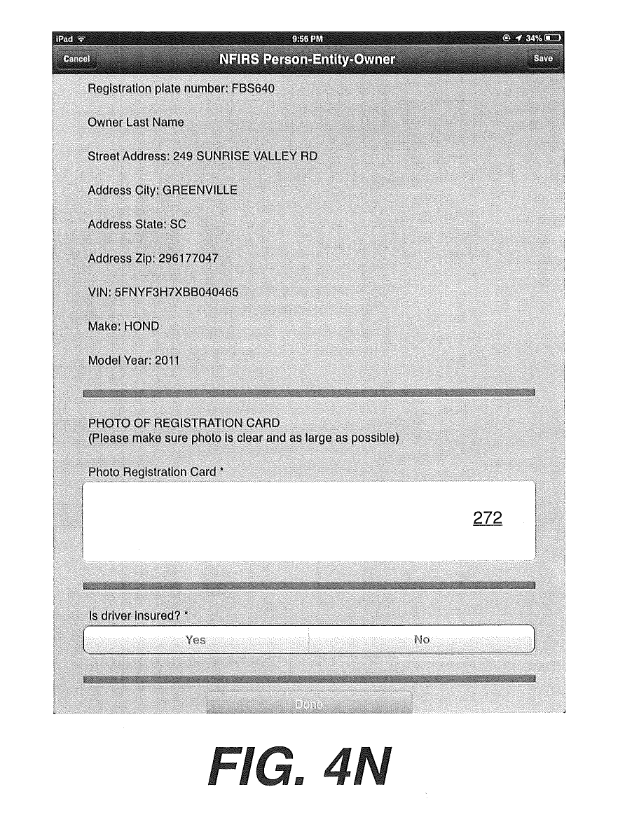

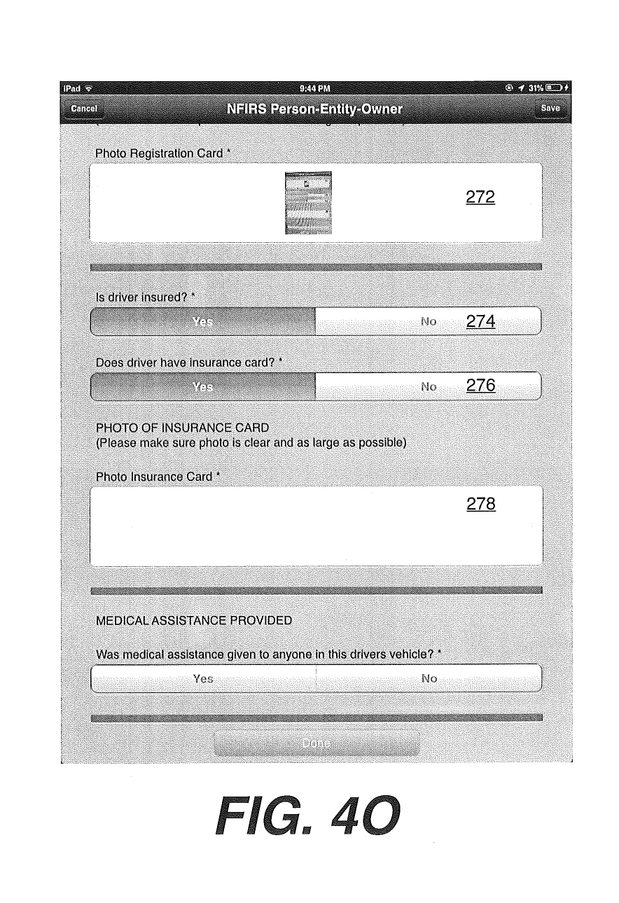

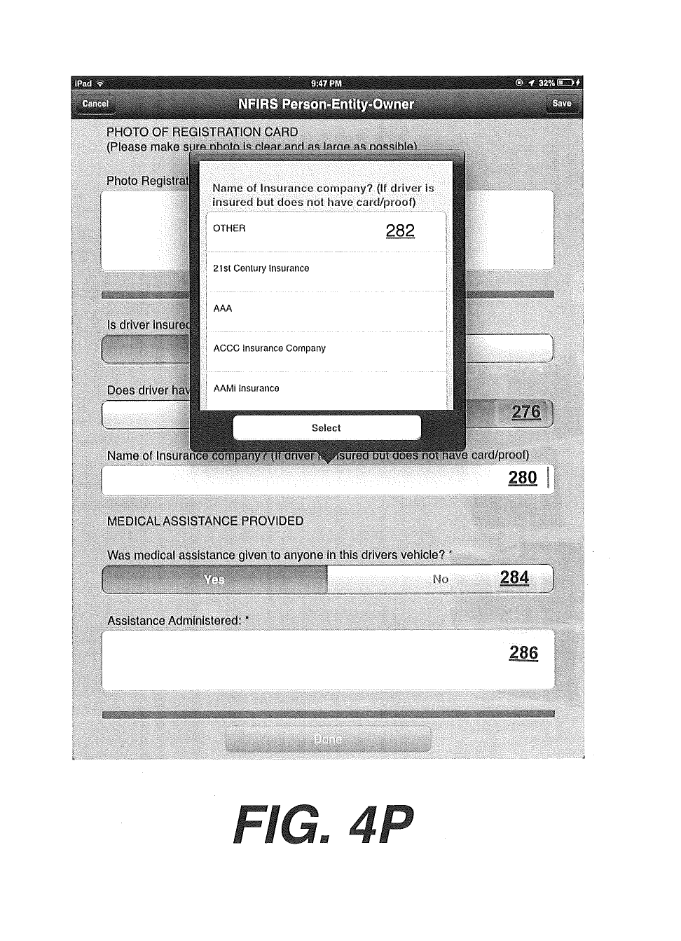

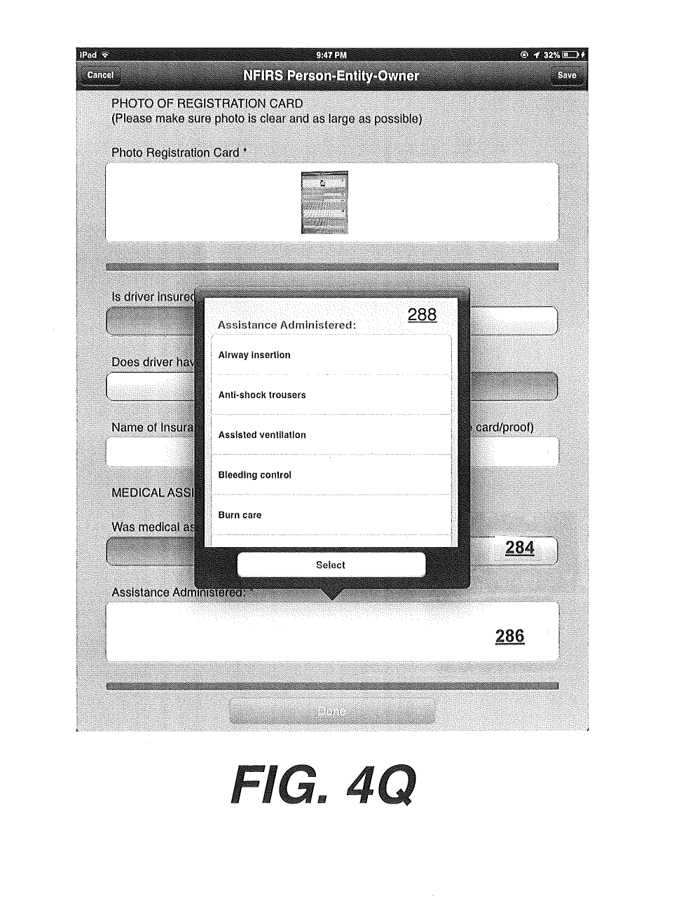

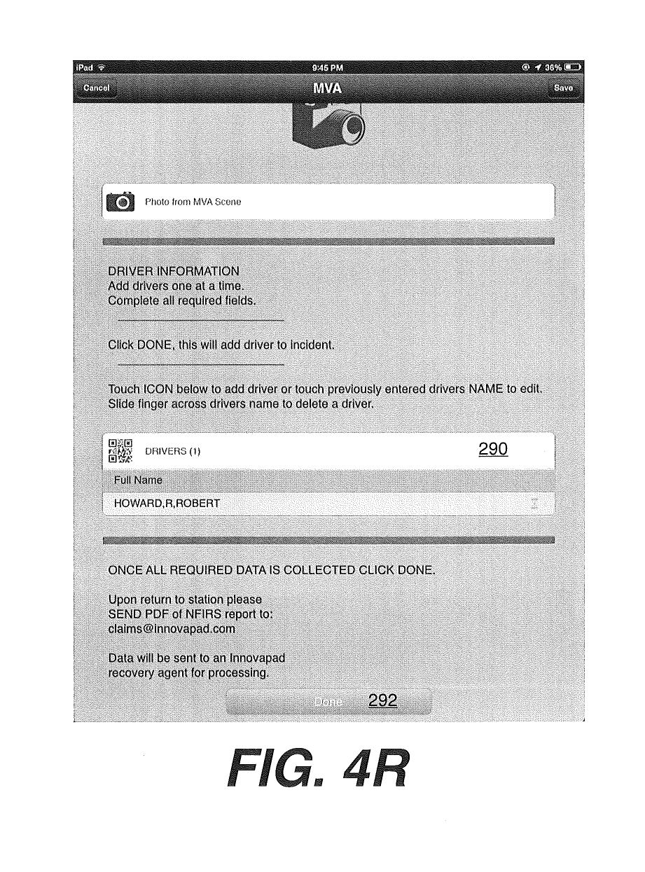

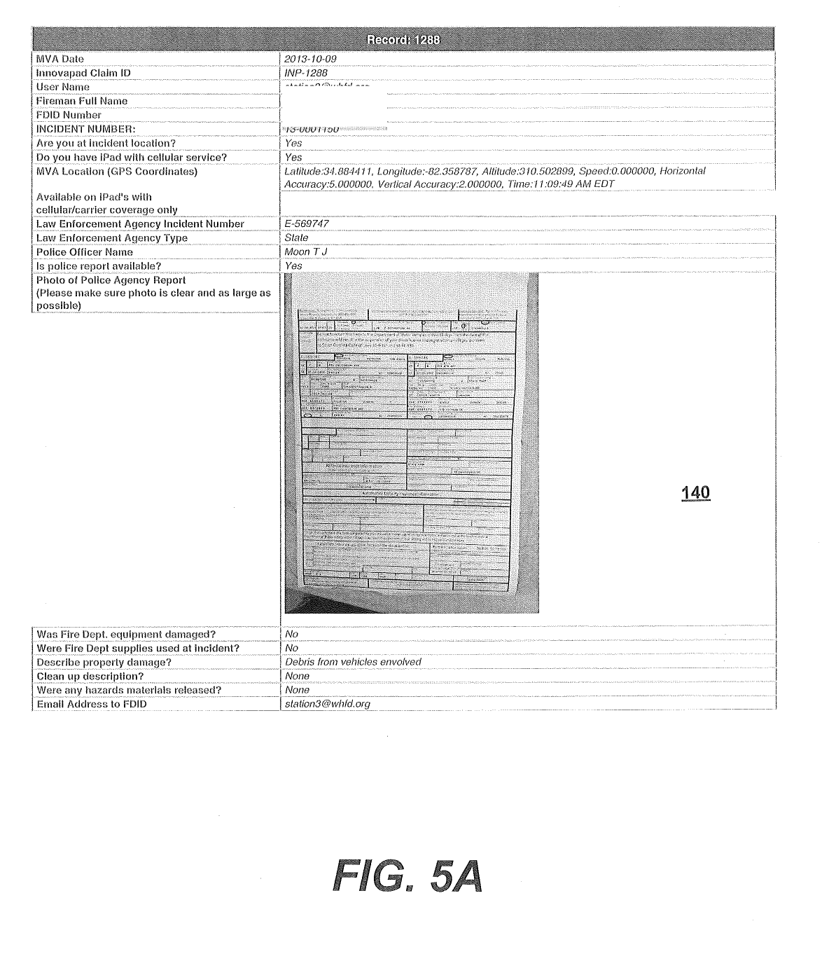

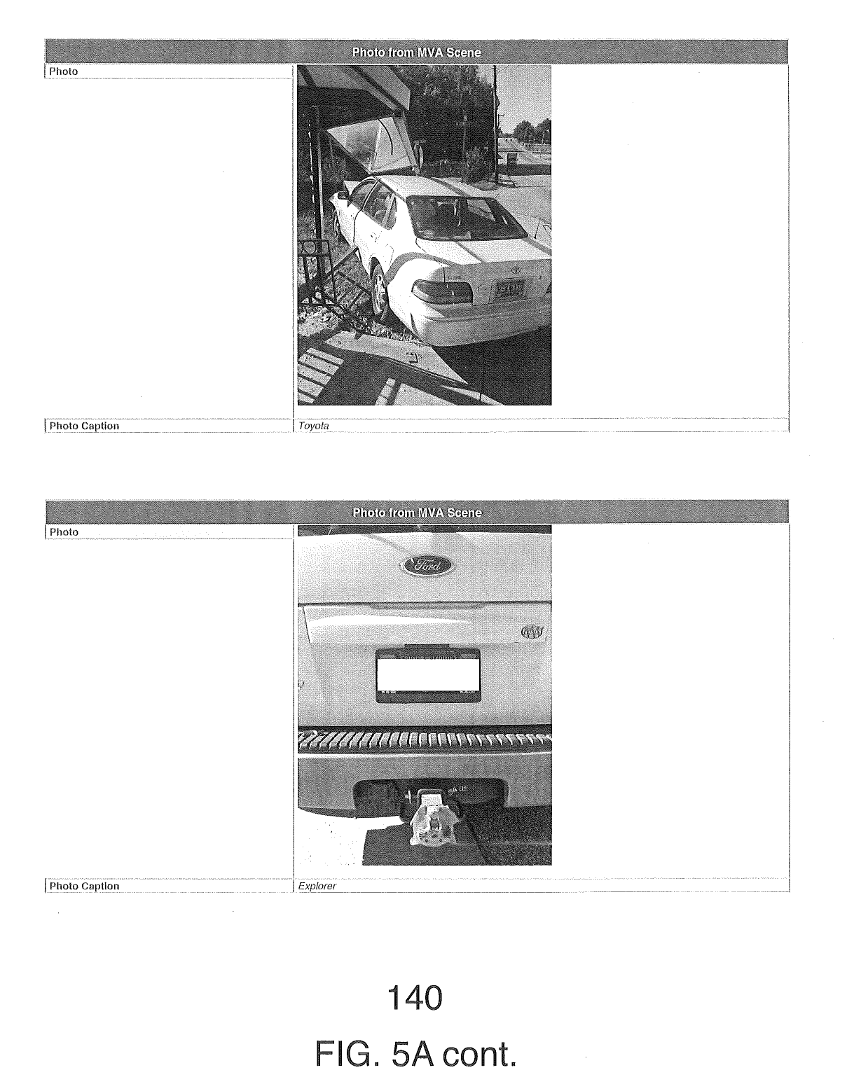

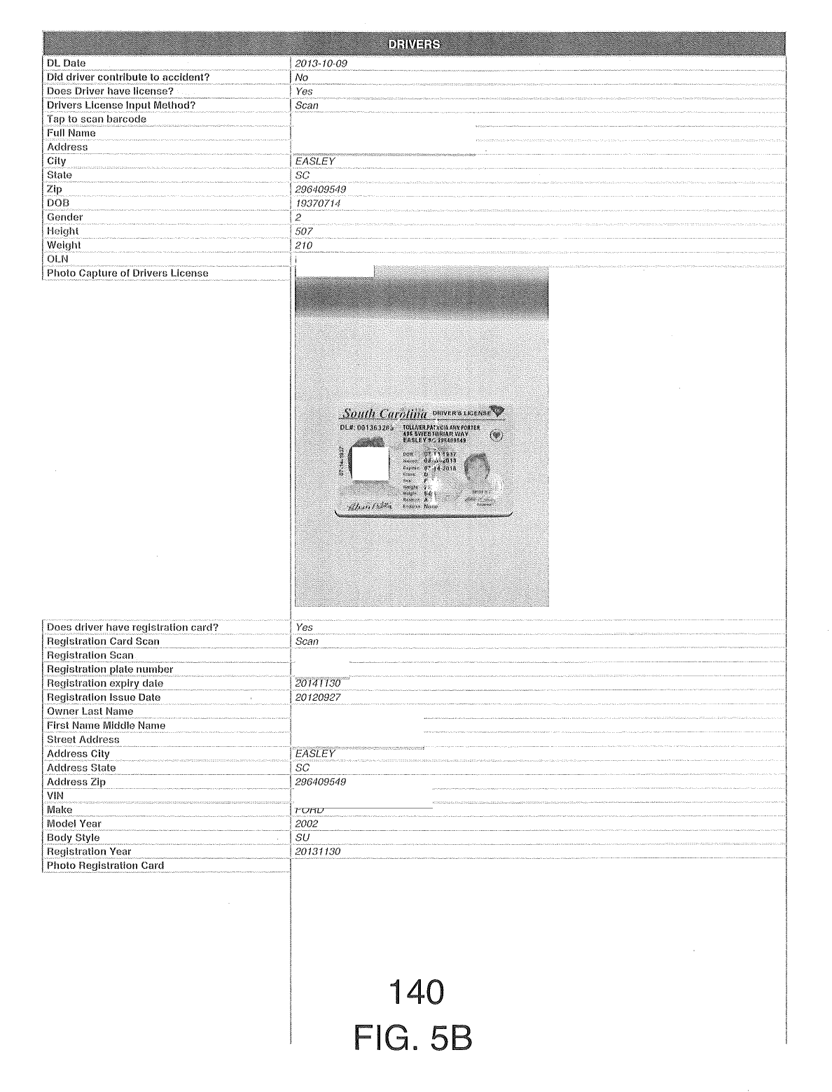

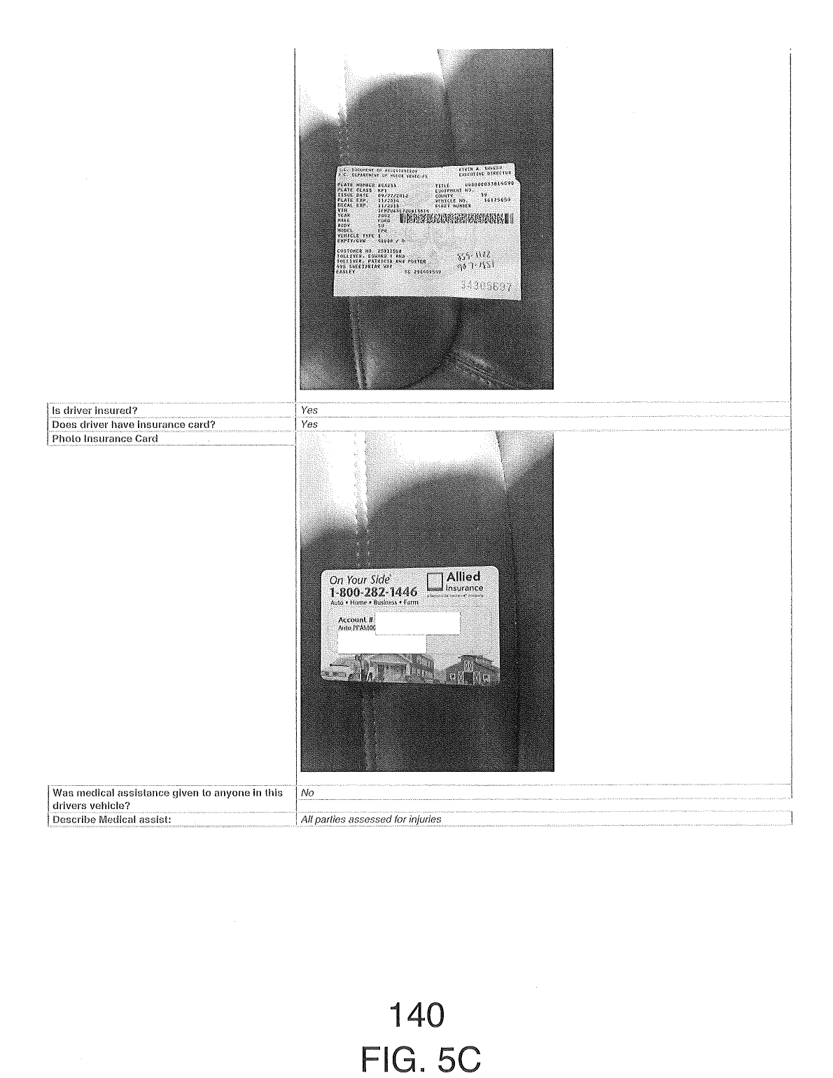

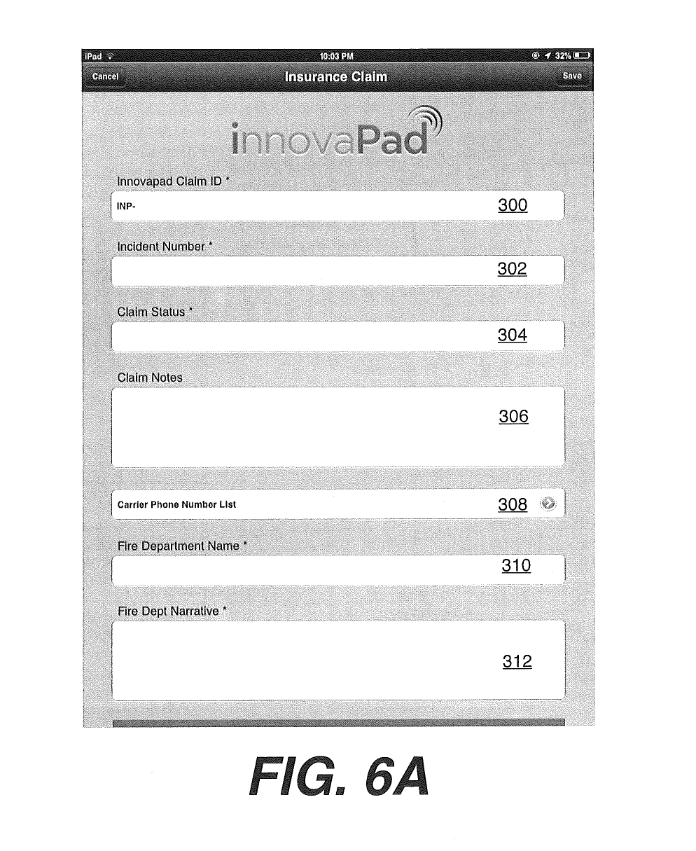

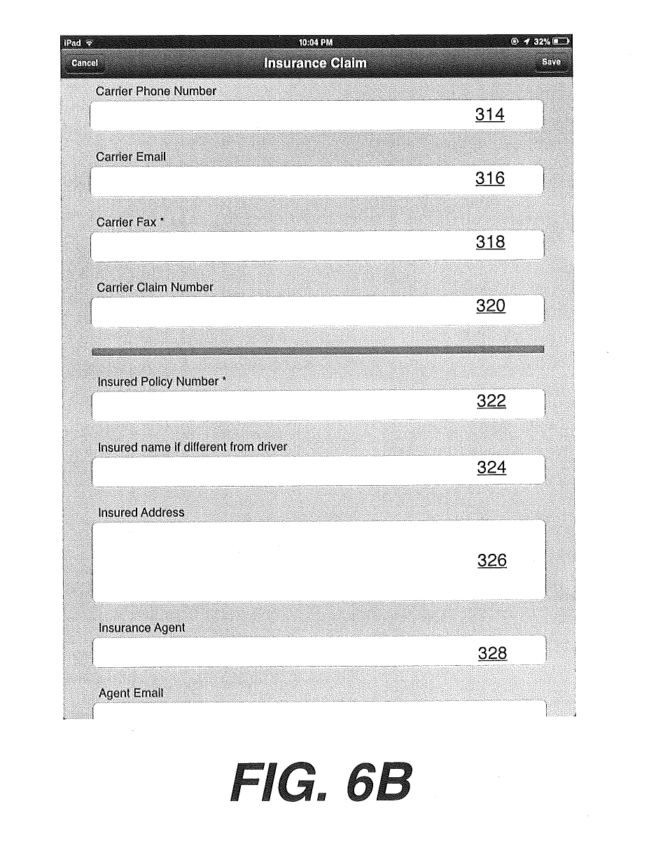

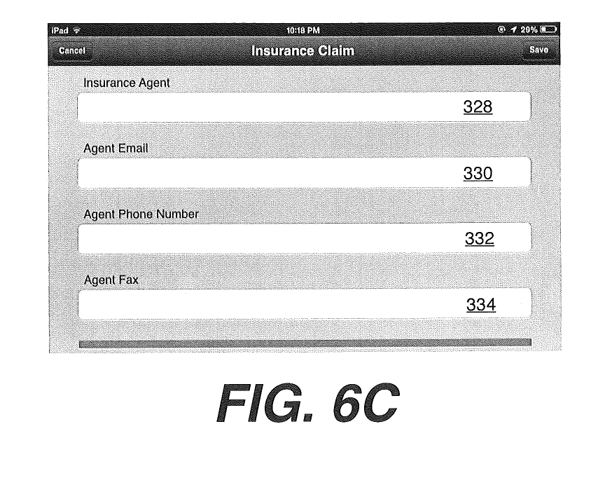

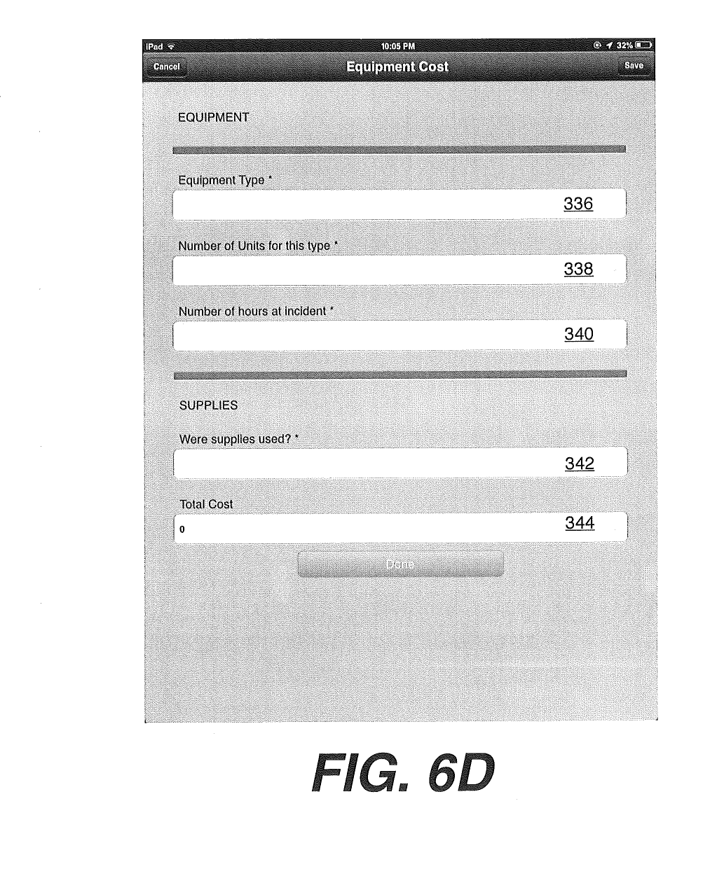

The MVA sub-program 700 may be used to collect data involving an incident such as an automobile accident. It may also include functionality to generate one or more reports based on the collected data including, for example, the incident report 140. Operation of this sub-program will be discussed in more detail below with reference to FIGS. 4-5. The Insurance Claim sub-program 702 is used to generate the insurance claims 26. Operation of this sub-program will be discussed in more detail below with reference to FIGS. 6-8. The Sales Status sub-program 704 may be used to track and facilitate sales efforts of the third party cost recovery provider. The FDID Information sub-program 706 may be used to collect and store information regarding each emergency responder organization that uses the third party cost recovery entity. The Claim Status sub-program 708 may be used to track the status of insurance claims 26 and send appropriate follow-up communications. The Training sub-program 710 may include, for example, videos, presentations and other training materials that may be used to train emergency responders on the use of the portable computing device and the MVA sub-program 700. In some embodiments, only the MVA sub-program 700 and the training sub-program 710 may be loaded (or enabled) on the portable computing devices 110 that are provided to emergency responder organizations.

As noted above, the MVA sub-program 700 may be used by emergency responders to collect data regarding an incident and to transmit that data to the cost recovery server 130. The data collection process will now be discussed in more detail with reference to FIGS. 4A-4R, which are a series of screen shots illustrating the information presented to a user on a display of the portable computing device 110 when the user runs the MVA sub-program 700 of the software application 112 to collect data regarding an incident such as the automobile accident 10.

As shown in FIG. 4A, the first screen that is displayed to the user on the display of portable computing device 110 includes instructional information 202 and a plurality of data entry blocks and buttons. Starting at the upper portion of the screen, the first data entry block 206 is a text field in which the date on which the incident occurred is recorded. In some embodiments, the software application 112 may use an auto-date function to automatically fill data entry block 206 with the date of the incident.

The second and third data entry blocks 208, 210 are also text fields in which the user may fill in the full name of the emergency responder who is collecting the data and the identifier used by the emergency responder organization to identify the particular incident at issue. The next two data entry blocks 212, 214 comprise pairs of “yes/no” buttons that each include an associated question. The first of these questions asks whether the user is presently at the location of the incident (i.e., the accident scene). The second question asks whether the remote computing device 110 currently has cellular service. If the user presses the “yes” button for both of data entry blocks 212 and 214, then the software application 112 may use a Global Positioning Satellite or other location identifying capability of the portable computing device 110 to determine a current location of the portable computing device 110, which is then inserted into the collected data 120 and displayed on the screen. If not, the user is prompted to enter a location of the incident into data entry block 216 in any appropriate format such as latitude/longitude, street address, nearest intersection, etc.).

Referring to FIG. 4B, the user may next be prompted to enter the incident number assigned to the incident by a responding law enforcement agency (e.g., police department) in data entry block 218. The user is also prompted to input the type of law enforcement agency (e.g., sheriff, city police, highway patrol, state trooper, etc.), along with the name of the police officer in charge of responding to the incident, in text fields 220 and 222, respectively. As shown in FIG. 4B, in some embodiments, selection of a particular text field such as the “Law Enforcement Agency Type” text field 220 may trigger a pop-up window 224 that allows the user to select the appropriate information from a list rather than having to type the information into the portable computing device 110.

Referring to FIG. 4C, the user next is presented with a yes/no button 226 and a question inquiring as to whether or not a police report has been completed at the scene of the incident. If the user selects the “yes” button 226 to indicate that the police report is available, the user is instructed to take a picture of the police report using a camera that is provided on the portable computing device 110. The picture of the police report (or pictures, for the case of a multi-page police report) are automatically inserted by the software application 112 into the collected data 120 and are displayed to the user in the data entry block 228. As shown in FIG. 4D, if the police report is not available, the user is prompted to take a picture of the license plate of the automobile driven by the at fault driver (or for all drivers, if the at-fault driver has not yet been identified). Once taken, this picture appears in data entry block 230.

Referring to FIG. 4E, the user is next prompted to input information regarding the incident and any supplies used by the emergency responders in responding to the incident and/or identification of any equipment that was damaged during the response to the incident. In some embodiments, the emergency responder's description of the incident may be entered orally using a microphone on the portable computing device 110 and then stored as an audio file. In most prior art systems, the description of the incident was handwritten on a form, which is a time consuming and laborious process that does not allow a user to easily fix mistakes and which is often difficult to read later when formal government reports are prepared. The difficulty of this traditional form of data entry may also encourage the emergency responder to provide an abbreviated description of the incident, which may be insufficient for many purposes such as NFIRS reports 22, insurance claims 26, criminal prosecutions, etc. In contrast, the audio notes that may be recorded using the systems and methods according to embodiments of the present invention may be readily recorded by an emergency responder as they walk around the incident site and may be edited using a “rewind” capability. The audio notes may be played back by the emergency responder later when preparing, for example, an NFIRS report 22. Moreover, in some embodiments, voice-to-text programs may be used to convert the audio file to text, and the text may be displayed to the user on the screen. As shown in FIG. 4E, in some embodiments, buttons 232 may be provided on the screen that the user may press to start and stop the audio recording. A progress indicator 234 may also be provided that provides an indication of the length of the audio recording. The text that is generated from the voice-to-text function may automatically be populated into data entry block 236.

As is further shown in FIG. 4E, a data entry block 238 is provided in the form of a “yes/no” button pair and an associated question that asks whether any fire department equipment was damaged during the response to the incident. As shown in FIG. 4F, if the user presses the “yes” button 238, a data entry block 240 appears in which the user can describe the equipment that was damaged (e.g., by typing in a description or via an audio recording with voice-to-text conversion). Similarly, a data entry block 242 is provided in the form of a “yes/no” button pair and an associated question that asks whether any fire department supplies were expended during the response to the incident. While not shown in FIG. 4F, if the user presses the “yes” button 242, a corresponding data entry block similar to block 240 may appear in which the user can describe the types and amounts of supplies that were used (e.g., by typing in a description or via an audio recording with voice-to-text conversion).

As is also shown in FIG. 4F, the user may next be prompted to take pictures of the accident scene using the camera on the portable computing device 110. As shown in FIG. 4G, as each picture is taken, a data entry block such as block 244 appears, and the picture is automatically populated into the data entry block 244. Additionally, a data entry block 246 also appears, and the user is prompted to enter a caption for the picture, which may be done by text entry, audio recording or the like. A data entry block 244 and a data entry block 246 will appear for each picture taken at the accident scene. Once the user has completed taking the picture, he may press a button 248 that is labeled “Done.”

Referring to FIG. 4H, the user is next prompted to collect information regarding each driver involved in the accident, and is instructed to tap on an icon to enter information relating to the first driver. Referring to FIG. 4I, it can be seen that the user is first asked to enter the expiration date on the driver's driver license in a data entry block 250. The user is also asked to select one of two buttons of a series of button pairs 252, 254, 256, 258 to specify whether the driver contributed (i.e., is an “at fault” driver) to the accident (“yes/no” button pair 252), whether the driver has a driver's license (“yes/no” button pair 254), the input method for the driver's license data (button pair 256, which indicates whether the driver's license data will be entered manually or via barcode scanning), and whether or not the driver has insurance (“yes/no” button 258). As is shown in FIG. 4J, if the user selects the “Scan” button of button pair 256, a data entry block 260 appears that the user may tap and then scan a barcode on the driver's license. The data encoded in the bar code is then read by the scanner of the portable computing device 110 and is displayed on the screen of the portable computing device 110 along with an indication that the scan was successful.

If the user selects the “Manual” button of button pair 256 instead of the “Scan” button, as shown in FIG. 4K, one or more data entry blocks 262 may be provided into which the user may manually enter data from the driver's license (e.g., via typing). In order to simplify the drawings, the only data entry block 262 is pictured in FIG. 4K is the data entry block 262 for the driver's full name as it reads on the driver's license, but it will be appreciated that the software application 112 may prompt the user to enter additional information from the driver's license for the driver at issue.

Referring to FIG. 4L, if the user selects the “yes” button 254, then the user is prompted to take a picture of the driver's license using the camera of the portable computing device 110. The software application 112 then inserts the picture of the driver's license captured by the camera and inserts the image into a data entry block 264.

Next, referring to FIG. 4M, a “yes/no” button pair 266 is presented to the user with a question asking whether the driver has a vehicle registration card. If the user selects the “yes” button, an additional “scan/manual” button pair 268 appears along with a question asking whether the user intends to scan the registration card. If the user indicates “scan,” then a data entry block 270 appears and the user is instructed to scan the registration card. Once the registration card has been scanned, the data embedded in the card may be displayed on the screen, as is shown in FIG. 4N. Additionally, the user is also asked to take a picture of the registration card using the camera on the portable computing device 110. The picture is then displayed in data entry block 272. While in the depicted embodiment, a scanning capability may be used to scan a barcode on a driver's license or a registration card, it will be appreciated that in other embodiments an optical character recognition capability of the portable computing device may be used coupled with known formats for state registration cards or driver's licenses which may be used to automatically extract the data from the driver's license or registration card.

Referring to FIG. 4O, the user is next presented with a “yes/no” button pair 274 and a question asking if the driver is insured. If the “yes” button 274 is selected, the user is then presented with a “yes/no” button pair 276 and a question asking if the driver has an insurance card. If the user selects the “yes” button 276, then the user is prompted to take a picture of the insurance card, which is inserted into a data entry block 278. Referring to FIG. 4P, if the user selects the “no” button 276, then data entry block 280 appears on the screen along with a prompt to enter the name of the insurance carrier therein. As shown in FIG. 4P, when the user selects block 280 a pop-up window 282 may appear that allows the user to select the insurance carrier 18 from a list in lieu of typing in the name of the insurance carrier, if desired.

Still referring to FIG. 4P, the user next is presented with a “yes/no” button pair 284 and a question asking whether or not medical assistance was provided to anyone in the car driven by the driver at issue. Referring to FIG. 4Q, if the user selects the “yes” button 284, then a data entry block 286 is displayed along with a prompt requesting that the user list the assistance that was administered. As is also shown in FIG. 4Q, a pop-up menu 288 may appear providing a list of medical assistance options which the user can select from instead of manually entering the information into data entry block 288. An additional data entry block (not shown) may be provided where additional details regarding the medical assistance that was administered may be entered. This may complete data entry for the driver at issue, and the user is asked whether there are any additional drivers involved in the incident. If there are, the above data collection steps are repeated for each additional driver. Once the data for all drivers involved in the accident have been entered, the data collection is completed.

Referring to FIG. 4R, once the MVA data collection program has been completed for the incident, a summary screen may appear on the display of the portable computing device that includes sub-folders for the pictures that were taken at the accident scene and for each driver involved in the accident. If necessary, the user may at this point go back and edit or delete any of the previously collected data, and may add any new data as necessary. Once the user is satisfied that all necessary data has been collected, the user may press the “Done” button 292. The user is advised that the collected data 120 for the incident will be sent to a third party cost recovery provider for processing. As discussed above with reference to FIGS. 2 and 3, at this point the collected data 120 for the incident may be transmitted from the portable computing device 110 to the cost recovery server 130 once a communications link is available therebetween. This data transfer may occur automatically in some embodiments. Once the collected data 120 for the incident is uploaded, the user is notified on the display of the portable computing device 110 that the collected data 120 was successfully uploaded, and the collected data 120 may then be deleted from the portable computing device 110.

In some embodiments of the present invention, upon receiving the collected data 120, the cost recovery server 130 may generate an incident report 140 the next time that the portable computing device 110 is in electronic communication with the cost recovery server 130. This incident report 140 may be automatically electronically transmitted to the emergency responder organization who collected the data 120. For example, in some embodiments, the cost recovery server 130 will automatically generate the incident report 140, embed the report in an e-mail, and transmit the e-mail to the emergency responder who collected the data 120 and to a pre-designated supervisor at the emergency responder organization. The individuals at the emergency responder organization may use the incident report 140 to complete any required official reports such as, for example, the NFIRS report 22 for the incident. In other embodiments, the incident report 140 will not be generated until a cost recovery agent 170 has become involved and completed certain preliminary steps such as, for example, assigning an identification number of the third party cost recovery entity for the claim associated with the incident and reviewing the incident report 140 to make sure it includes all of the necessary information.

FIGS. 5A-5C illustrates an example incident report 140 according to embodiments of the present invention that may be forwarded to the emergency responder organization. In the depicted embodiment, the incident report 140 is embedded in an e-mail. Three figures are used to depict the incident report 140 as it will typically be a multi-page document (when printed). As shown in FIGS. 5A-5C, the incident report 140 may include most (or all) of the data 120 that the emergency responder collected at the accident scene, conveniently placed into an organized and easily readable format. The pictures that were taken at the accident scene (including pictures of the accident scene, driver's licenses, license plates, registration cards, police reports, insurance cards, etc.) are embedded in the e-mail as small, low resolution pictures. The emergency responder may simply click on these pictures to download a full-sized high resolution version of the picture from the cost recovery server 130. The emergency responder may prepare any required official reports electronically by simply copying and pasting the relevant information (text, pictures, etc.) from the incident report 140 into the electronic form for the official government report.

As noted above with reference to FIG. 3, when the collected data 120 is received at the cost recovery server 130, an automated process may be initiated in which a routing agent 160 is notified that the data 120 has been received (e.g., by a text message or e-mail) and in response to this notification the routing agent 160 then assigns the incident to a cost recovery agent 170 who will be in charge of cost recovery for this potential claim. Once the incident is assigned to a cost recovery agent 170, the cost recovery agent 170 may initiate the insurance claim process using, for example, the software application 132 running on the cost recovery server 130. FIGS. 6A-6D illustrate data entry screens that may be presented to the cost recovery agent 170 on an electronic device (e.g., a computer) so that the cost recovery agent 170 may initiate the insurance claims process. Before beginning this process, the cost recovery agent 170 may contact the insurance carrier 18 by, for example, telephone or e-mail to advise the insurance carrier 18 that a claim is being prepared and to receive the claim number that the insurance carrier 18 is assigning to this insurance claim 26. This allows the system to match up the identification number for the insurance claim 26 that is assigned by the third party cost recovery entity to the identification number assigned to the claim by the insurance carrier 18, thereby assuring that all future communications regarding the insurance claim 26 can be properly routed by both the third party cost recovery entity and the insurance carrier 18.

As shown in FIG. 6A, the initial screen includes a plurality of data entry blocks 300, 302, 304, 306, 308, 310, 312 into which the cost recovery agent 170 is asked to enter various information relating to the insurance claim 26. An identification number for the insurance claim 26 that is assigned by the third party cost recovery entity (which typically is the employer of the cost recovery agent 170) is entered into data block 300. This data entry block 300 may, in some embodiments, be automatically filled in by the software application 132, which can assign the next available identification number in sequence. Data block 302 is for the incident number assigned to the incident by the responding emergency responder organization. Data blocks 304 and 306 request entry of the claim status (e.g., unfiled, pending, once rejected, twice rejected, appealed, completed, etc.) and any special notes regarding the insurance claim, respectively. Data entry block 308 provides a “Carrier Phone Number List” which is an expandable list (by clicking on the arrow at the right side of the data entry block). Data entry blocks 310 and 312 are filled in to indicate the emergency responder organization that is making the insurance claim 26 and the narrative of the incident that was compiled by the emergency responder at the scene of the incident, respectively.

Some of the above-described data entry blocks (e.g., block 304) may include an associated pop-up windows so that the cost recovery agent 170 may select from a plurality of pre-defined entries as opposed to having to type the information into the data entry block each time. Other data entry blocks may be auto-filled by the software application 132 using information from the collected data such as, for example, blocks 302, 310 and 312. Still other data entry blocks may be auto-filled using information stored on the cost recovery server 130 in conjunction with information contained in the collected data 120. For example, the software application 132 may reference the insurance carrier information for the at fault driver from the collected data 120 and then use this to identify and fill in the insurance carrier telephone number, facsimile number, etc.

As shown in FIG. 6B, the insurance carrier contact information that may be entered into the insurance claim data set includes a telephone number 314, a facsimile number 316, and an e-mail address 318 for the insurance carrier 18, along with the claim number 320 that the insurance carrier 18 has assigned to this claim. The policy number (block 322) and the name (block 324) of the insured individual (who typically is the at fault driver or a relative of the at fault driver), along with the address of the insured individual (block 326) are also entered. These data entry blocks 322, 324, 326 may be auto-filled by the software application 132 if this data was included in the collected data 120 (which would typically be the case if an insurance card for the insured entity was scanned at the accident scene) or may be filled in the cost recovery agent 170 using information obtained from the insurance carrier 18. As shown in FIG. 6C, information regarding any insurance agent including the agents name (block 328), e-mail address (block 330), telephone number (block 332) and facsimile number (block 334) may also be filled in by the cost recovery agent 170 or auto-filled, if the information is available.

Referring to FIG. 6D, the cost recovery agent 170 may next enter information that is used to establish the amount of the insurance claim 26. The entered information includes the type of equipment used in responding to the incident (block 336), which typically is an identification of a vehicle such as a fire truck, an ambulance etc. The cost recovery agent 170 also enters the number of each type of equipment/vehicle that was used (block 338), and the number of hours that the equipment was present at the scene of the incident (block 340). Information is also input regarding the type and quantity of supplies used (block 342, which opens up a sub-menu for entry of the supplies information). Typically, the third party cost recovery entity will maintain a “price list” for each emergency responder organization that it files insurance claims for on the cost recovery server 132. This price list will identify, for example, the cost charged per hour by the emergency responder organization for each type of fire truck, ambulance, police car or other equipment that is used in responding to an incident. The price list may also include prices charged for different types of supplies that may be used in responding to an incident (e.g., flares, fire extinguishers, etc.). The software application 132 will use the data entered by the cost recovery agent 170 regarding the equipment and supplies used in the response and the price list to automatically compute the amount of the insurance claim 26.

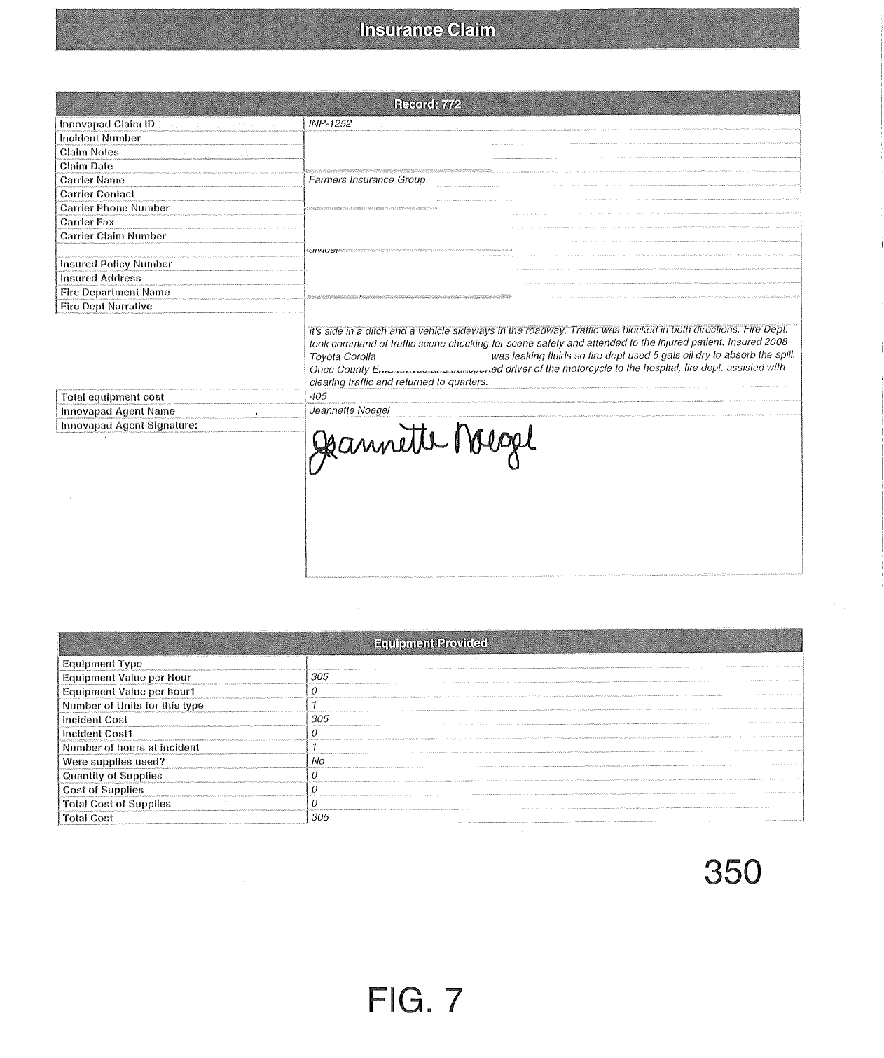

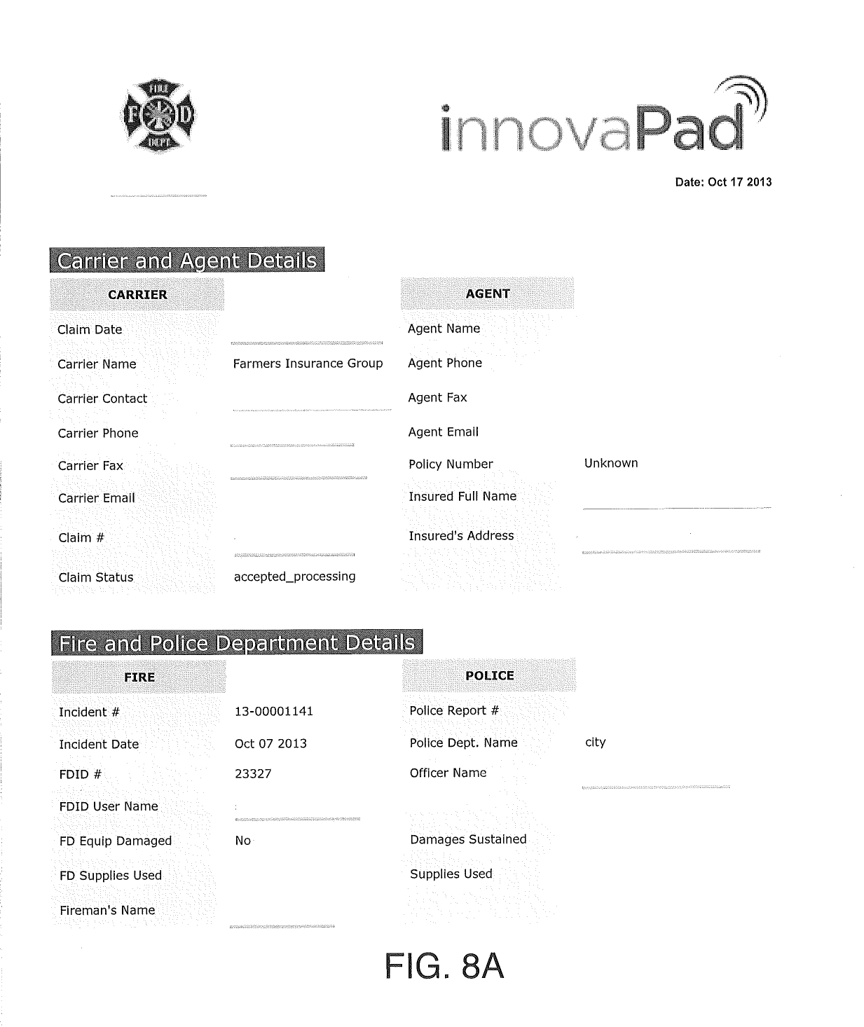

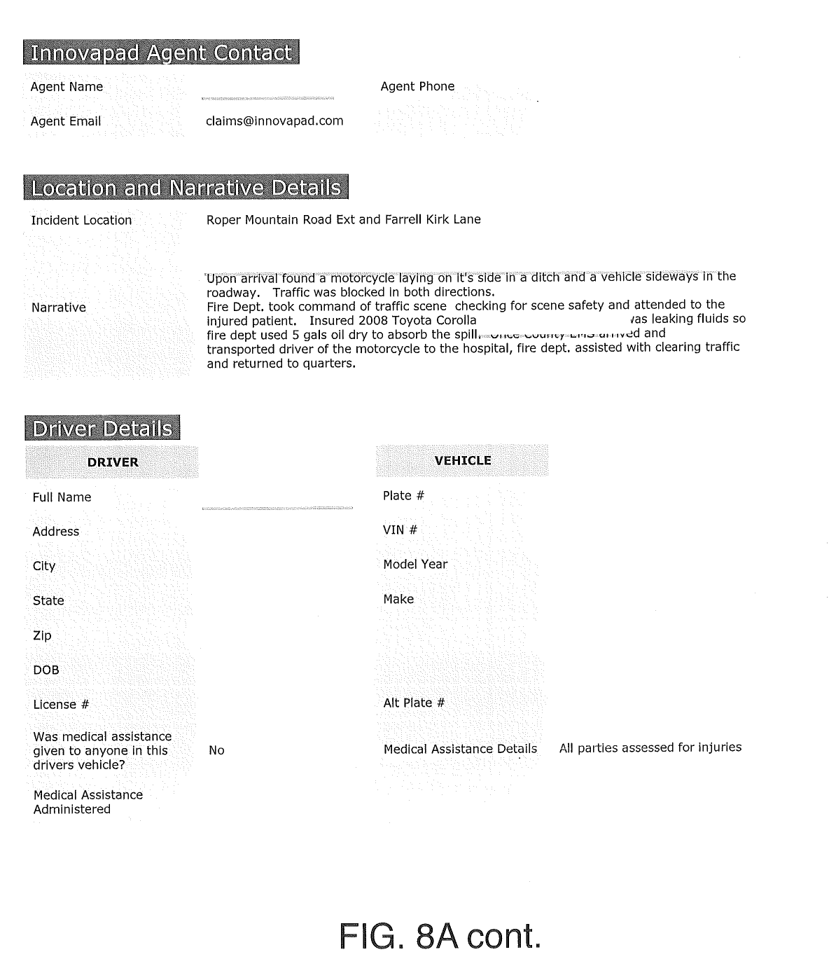

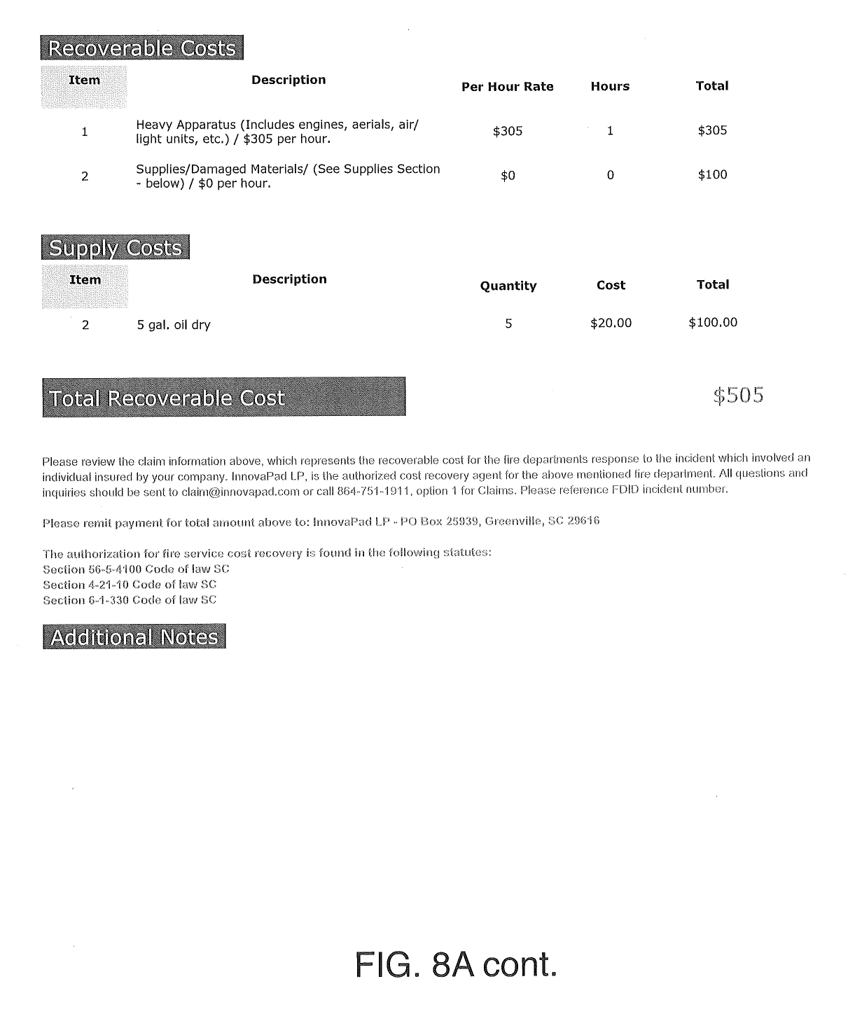

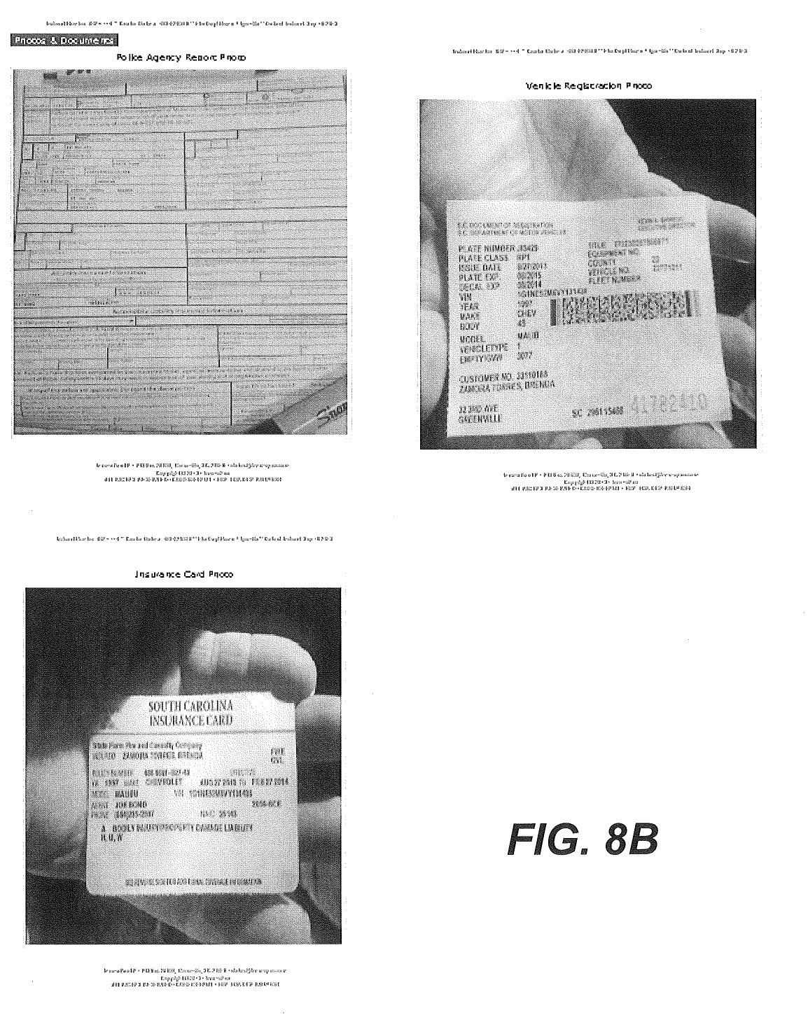

Once the cost information has been entered, the cost recovery agent 170 may select the “Submit” button 344. In response thereto, the software application 132 generates an internal insurance claim report 350 and an actual insurance claim 360. An example internal insurance claim report 350 is depicted in FIG. 7, while FIGS. 8A-8B illustrate an example insurance claim 360, which is typically a multi-page report that is submitted to the insurance carrier 18 via facsimile.

The insurance claim 360 may be automatically created from the incident report 140 and from the cost recovery information entered by the cost recovery agent 170 as shown above with respect to FIGS. 6A-6D. In some embodiments, the incident report 140 and the cost recovery information may be merged together into a single document that is sent to the insurance carrier 18 using, for example, a web-based document merge tool 180 such as, for example, Google Docs (see FIG. 3). As shown in FIGS. 8A-8B, the insurance claim 360 may include, for example, the narrative of the incident, identification of the various costs incurred and include supporting documentation such as the police report 20, pictures of registration and insurance cards, etc. While not shown in the particular example of FIGS. 8A-8B, other information such as pictures of the scene, a picture of the driver's license of the at fault driver, a picture of the license plate of the vehicle driven by the at-fault driver, a PDF of NFIRS report 22, etc. may also be included in the insurance claim 360. A separate invoice for the claimed recoverable cost may also be automatically generated by the cost recovery server 130 and forwarded to the insurance carrier 18 as part of the insurance claims 360.

The cost recovery server 130 may then forward the insurance claim 360 and any associated invoice to the insurance carrier 18. Under current practice, insurance claims 360 are typically sent to most insurance carriers 18 by facsimile. In some embodiments, the software application 132 will prompt the cost recovery agent 170 to draft a personalized note that will accompany the insurance claim 360. The cost recovery server 130 may forward the insurance claim 360 and any associated invoice and/or personalized note to a facsimile service 190 (see FIG. 3) such as, for example, an e-mail-to-facsimile service that will convert an e-mail that is received from the cost recovery server 130 into a facsimile and transmit the facsimile to a designated facsimile number (i.e., a facsimile number of the insurance carrier 18). The facsimile service may return electronic communications (e.g., e-mails, facsimiles, etc.) confirming that the facsimile service 190 received the communication from the cost recovery server 130 and/or that the facsimile of the insurance claim 360 was successfully received by the insurance carrier 18.

Unfortunately, simply submitting an insurance claim 360 is typically insufficient to obtain payment on a cost recovery claim. Instead, a back and forth process is often required between the third party cost recovery entity and the insurance carrier 18 before a claim may be paid. This process may include requests for additional information, denials of the claim, etc. Consequently, pursuant to embodiments of the present invention, the software application 132 running on the cost recovery server 130 may include additional functionality that may partially automate the insurance claim process.

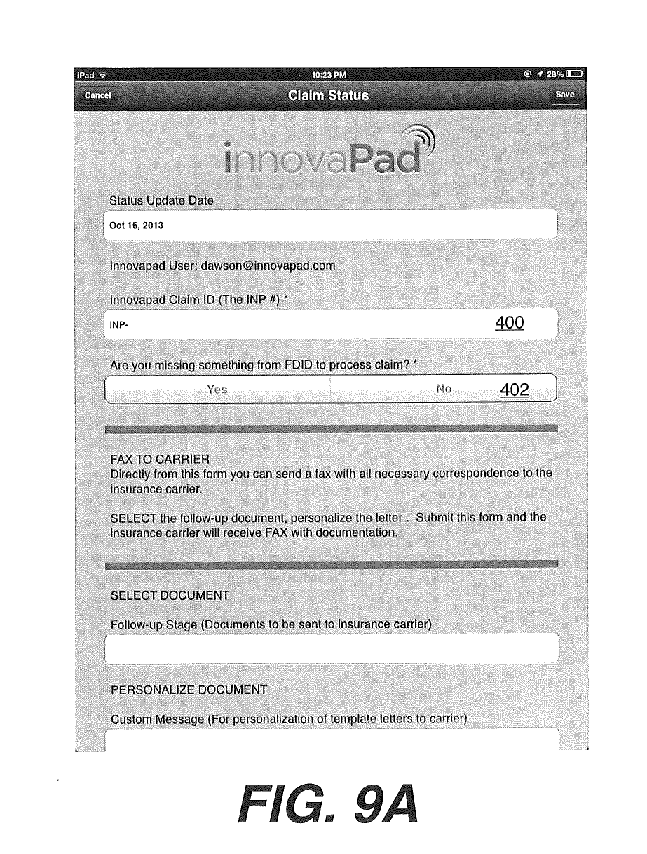

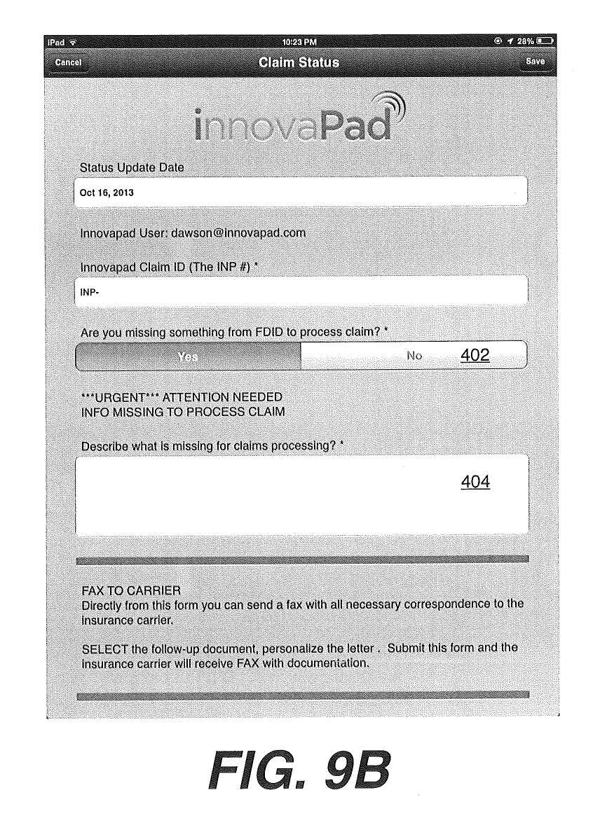

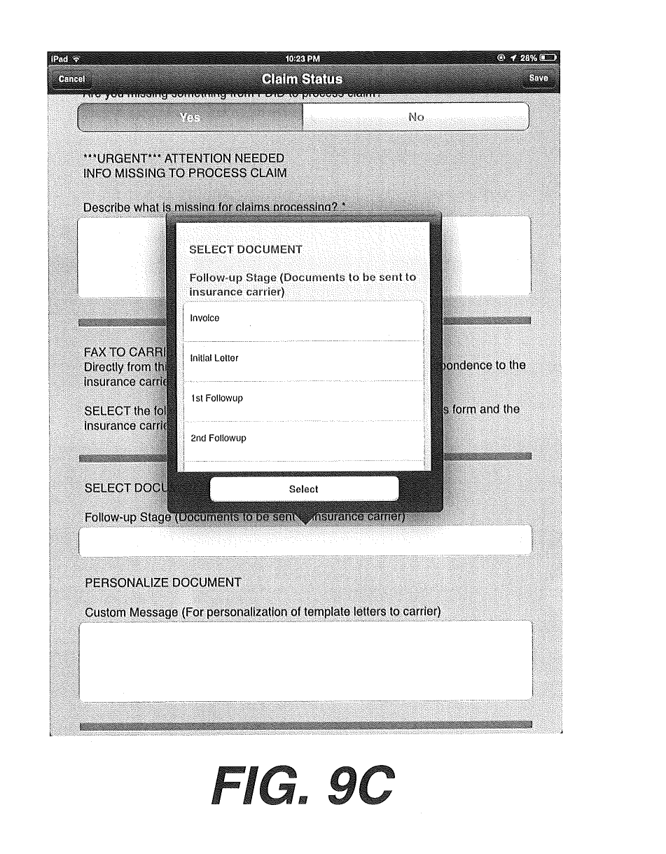

For example, in some embodiments, the software application 132 may include a Claim Status sub-program 708 (see FIG. 13) that facilitates communications between the third party cost recovery entity and the insurance carrier 18 regarding a specific claim. FIGS. 9A-9C illustrate this functionality. As shown in FIG. 9A, the cost recovery agent 170 may track the status of a particular insurance claim 26 by entering the third party cost recovery identification number for the insurance claim 26 at block 400. The Claim Status sub-program 708 will notify the agent 170 at block 402 if any information is still outstanding (e.g., the NFIRS report 22) that is necessary for processing the claim. FIG. 9A also illustrates how the cost recovery agent 170 may automatically send a facsimile to the insurance carrier 18 from the software interface, and also illustrates how the cost recovery agent 170 may readily personalize any communications that are sent through this software interface.

With reference to FIG. 9B, it can be seen that if at block 402 there is an indication that information is still needed from the emergency responder organization, the cost recovery agent 170 may draft a personalized note describing the information that is missing (block 404), which the Claim Status sub-program 708 will then cause to be transmitted electronically to the emergency responder organization. As shown in FIG. 9C, similar communications may readily be sent to the insurance carrier 18, typically via the facsimile service 190 (see FIG. 3). As shown in FIG. 9C, the Claim Status sub-program 708 may include template communications to the insurance carrier such as an invoice, an initial claim letter, a first follow-up letter, a second follow-up letter, an initial response to a denial, etc. that the cost recovery agent 170 may select as appropriate. These documents are automatically prepared using pre-stored templates and information from the insurance claim 26, the incident report 140, etc. The cost recovery agent 170 may also further personalize the document before it is forwarded to the insurance carrier 18.

The server software application 132 may also be used to track the status of pending insurance claims. The status information may be accessible to the cost recovery agent 170 and may be formatted into various reports (e.g., a report providing the status of all pending claims for a particular emergency responder organization). In some embodiments, authorized parties such as individuals associated with an emergency responder organization that responded to the incident and/or an individual being charged for cost recovery can access the cost recovery server 130 to view the status of a particular claim. These reports may also or alternatively be forwarded to the emergency responder organizations on, for example, a daily or weekly basis.

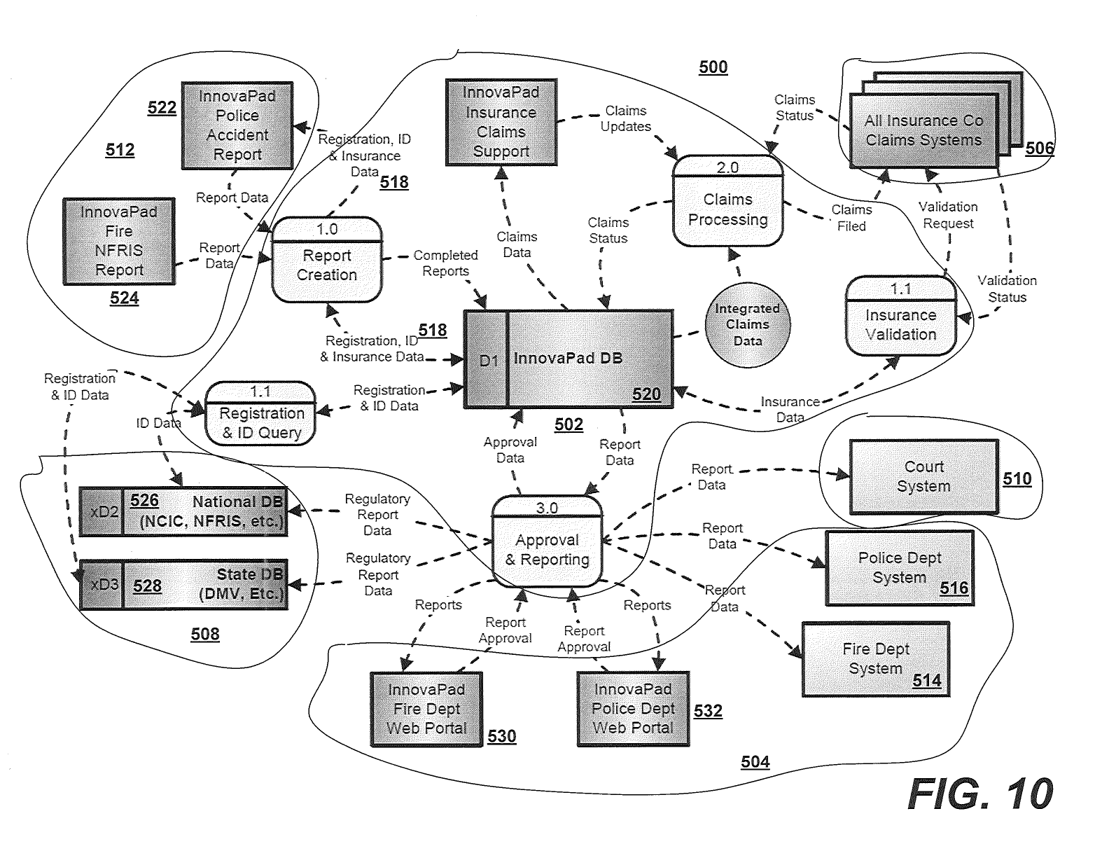

FIG. 10 is a schematic block diagram illustrating the functionality of a cost recovery system 500 according to further embodiments of the present invention. As shown in FIG. 10, the system 500 may include a third party cost recovery provider 502, emergency responders 504, insurance carriers 506, incident reporting databases 508 and other outside parties 510.

An incident such as, for example, an automobile accident may occur at an incident scene 512. Emergency responders such as a fire department 514 and police department 516 may respond to the accident. Data 518 relating to the accident may be collected by an emergency responder using a portable computing device (not shown) at the accident scene 512. In the embodiment of FIG. 10, the collected data 518 is transmitted to a cost recovery server 520 of the third party cost recovery provider 502. A software application running on the cost recovery server 520 generates official reports for an incident using the collected data 518. These official reports may include, for example, a police report 522 and an NFIRS report 524. In these embodiments, the format requirements for the various reports 522, 524 that are required by each specific jurisdiction may, for example, be stored in a data store of the cost recovery server 520 or obtained by the cost recovery server 520 by communicating with another database containing the relevant formatting information. The software application may be configured to automatically generate the various reports 522, 524 that are required by a specific jurisdiction in the format that is specified for that jurisdiction using the collected data 518.

As is further shown in FIG. 10, the cost recovery server 520 may be in communication with one or more national databases 526 and/or state databases 528. In such embodiments, the cost recovery server 520 may use individual identification information that is included in the collected data 518 to query the databases 526, 528 in order to retrieve additional information associated with an individual involved in the incident such as, for example, the at fault driver. For example, if the collected data 518 includes a driver's license number for the driver that was determined to be at-fault with respect to a particular automobile accident, this driver's license number or other identifying information such as, for example, a name, address, phone number and/or the like may be used to retrieve associated information regarding the at-fault driver including for example, the insurance carrier of the at-fault driver and the insurance policy number. In embodiments where the portable computing device has communications connectivity, the identifying information may be electronically transmitted to the cost recovery server 520 while the emergency responder is still at the accident scene 512, and the cost recovery server 520 may transmit a query to an identified insurance carrier 506 in order to obtain full insurance information that is transmitted back to the emergency responder while he/she is still at the accident scene 512. This may allow the emergency responder to collect additional information if the initially collected information is insufficient to allow identification of the insurance information necessary to file a cost recovery insurance claim.

The system 500 may also provide functionality so that the emergency responder organizations may view, edit and approve the official reports 522, 524 electronically. In particular, as shown in FIG. 10, one or more emergency responder interfaces such as a fire department web portal 530 and a police department web portal 532 may be provided. A SaaS or ASP architecture, for example, can be used to implement this functionality allowing the emergency responders to access data and/or reports stored on the cost recovery server 520 for various functions. For example, when the cost recovery server 520 generates an official report (e.g., an NFIRS report 524), the report 524 needs to be approved in many municipalities before it may be issued as a formal “original” report. The cost recovery server 520 may prepare a draft report based on the collected data 518, and this draft report may be stored on the cost recovery server 520. An individual associated with the emergency responder organization (e.g., the individual who collected the data 518, a supervisor, etc.) can retrieve the draft report using an interface such as the interfaces 530, 532. The draft reports can be retrieved by any number of methods such as date, location, individual responder, individuals involved with the accident, estimated damage amount, time, date and information that is gathered by the first responder

When the draft report is retrieved, the retrieving individual (e.g., the emergency responder who collected the data 518 or a supervisor) may verify that the information included in the draft report is accurate, that the report format is appropriate, that the draft report is complete, and may also verify any other appropriate criteria. If problems or shortcomings are identified, the reviewing individual can edit and/or add information to the draft report, if necessary. Once the draft report is complete and acceptable, the retrieving individual can approve the draft report, thereby turning it into the official report 522 or 524. In some embodiments, once the report 522, 524 is finalized and approved, the report may no longer be edited. In some embodiments, the report may be digitally signed so that any changes (authorized or not) to the report can be detected. In some embodiments, all draft versions of the report may be stored along with the finalized report. Once the report 522, 524 is finalized, it can be stored on the cost recovery server 520. It may also be submitted electronically to an appropriate receiving entity (e.g., the NFIRS database 526).

As is further shown in FIG. 10, the cost recovery server 520 may be in electronic communication with other third party systems, including but not limited to, a court system 510, and servers associated with the police department 516 and/or the fire department 514. In such embodiments, the finalized reports 522, 524 can be automatically transmitted to one or more of these third parties. Other individuals and organizations may also be provided limited access to selected ones of the final reports 522, 524 such as attorneys or medical providers.

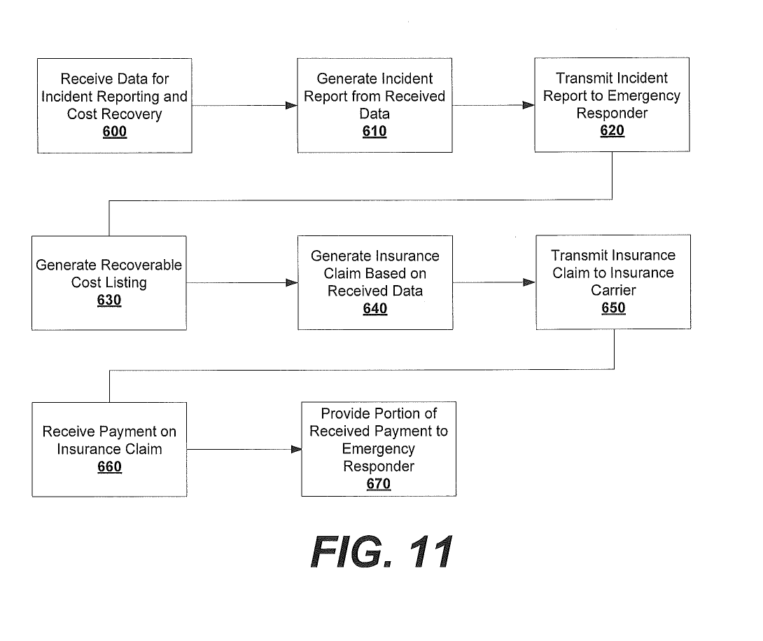

FIG. 11 is a flow chart illustrating methods of performing emergency responder cost recovery according to embodiments of the present invention. As shown in FIG. 11, pursuant to these methods, data may be electronically received from a remote, portable computing device, the data including information that may be used to compile an incident report and an insurance claim (block 600). This received data may then be used to automatically generate an incident report (block 610). The incident report may be electronically transmitted to an emergency responder organization (block 620). A recoverable cost listing may also be generated (block 630), and an insurance claim may be generated based on the received data (block 640). The insurance claim may be electronically transmitted to an insurance carrier (block 650). Payment may thereafter be received from the insurance carrier for the insurance claim (block 660). A portion of the received payment may be provided to the emergency responder organization (block 670).

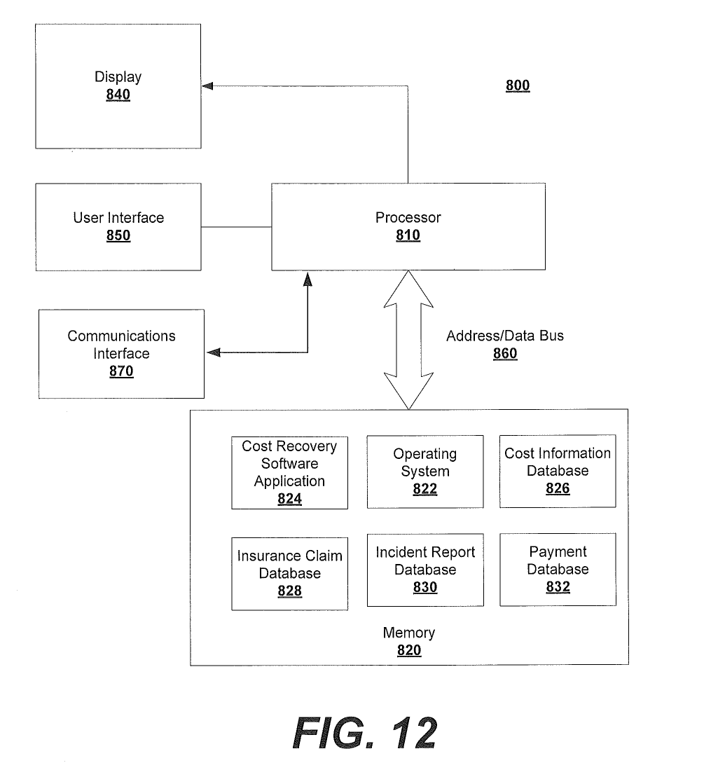

FIG. 12 is a block diagram of a cost recovery server 800 according to embodiments of the present invention. As shown in FIG. 12, the cost recovery server 800 includes a processor 810, a memory 820, a display 840, a user interface 850, an address/data bus 860 and a communications interface 870.

The processor 810 may communicate with the memory 820 via an address/data bus 860. The processor 810 can be any appropriate processor, such as processors that are used in commercially available servers. The memory 820 is representative of the overall hierarchy of memory devices. The memory 820 can include, but is not limited to, the following types of devices: cache, ROM, PROM, EPROM, EEPROM, flash memory, SRAM, and DRAM. As shown in FIG. 12, the memory 820 may include, for example, an operating system 822 and a cost recovery software application 824. The cost recovery software application 824 may be the above-described software application 132. The memory 820 may also include a number of databases that store information and reports that are used and/or generated in the incident reporting and cost recovery processes. These databases may include a cost information database 826 where pricing of each emergency responder organization may be stored, an insurance claim database 828 in which completed insurance claims 26 are stored along with information on status tracking of insurance claims 26, an incident report database 830 in which incident reports 140 are stored, and a payment database 832 that is used to track payments received from the insurance carriers 18 and payments made to the emergency responder organization. It will be appreciated that the memory 820 may include other standard components such as, for example, input/output (I/O) device drivers that are not pictured in FIG. 12 in order to simplify the drawing. It will also be appreciated that the various elements of server system 800 may be located on a single device or distributed across multiple devices that may be located at different locations.

The above-described systems and methods according to various embodiments of the present invention may have certain advantages over prior art cost recovery techniques. As one example, in some embodiments, the data collection process may be partially automated by, for example, using a bar code scanning capability of the portable computing device 110 to scan bar codes included on a drivers license, vehicle registration and/or insurance cards so that the information embedded in the bar code is automatically added to the collected data 120 without any need to manually enter this information into the software application 112. As another example, a camera on the portable computing device 110 may be used to capture images of items such as the police report, the license plates of vehicles involved in an accident, driver's licenses or other identification of individuals involved in the incident, vehicle registration forms, insurance cards, etc. Information that is included in these images may then be manually input into the incident report 140 at a later time, if necessary or may alternatively be extracted and automatically input using, for example, optical character recognition software.

As another example, the systems and methods according to embodiments of the present invention may facilitate cross-departmental indexing and efficiencies. By way of an illustrative example only, if the first emergency responder to arrive at a scene of a car accident is a fire fighter, the fire fighter may use the portable computing device 110 to immediately start collecting the above-described data 120, leaving the determination of driver fault and/or liability to be assessed by the responding police officer. Once liability/fault has been determined, it may be entered into the portable computing device 110 and the incident data 120 may thereafter be forwarded to the cost recovery server 130 for use in preparation of the incident report 140. If desired, the incident report 140 may be forwarded to both the police department and the fire department for use in preparing their respective police report 20 and fire reports 22, 24.

As yet another example, another feature provided by embodiments of the present invention is the transmission of full data regarding an incident to a single, centralized location. As discussed above, in many prior art systems, information regarding an incident is collected by different agencies and stored at different entities in databases that are not electronically connected to each other. Moreover, as the information is transmitted electronically, to/from insurance, police, fire, federal, court computers, transactions are faster and more accurate, and manual data re-entry is reduced

Embodiments of the present invention have been described above with reference to the accompanying drawings, in which embodiments of the invention are shown. It will be appreciated, however, that this invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. are used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements and/or components, but do not preclude the presence or addition of one or more other features, operations, elements, components and/or groups thereof.

As will be appreciated by one of skill in the art, embodiments of the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including, for example, hard disks, CD-ROMs, optical storage devices, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Embodiments of the present invention have been described above with reference to flowchart illustrations and block diagrams. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, implement the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. For example, any number of RF output ports may be supported by the various amplifier embodiments discussed herein.

That which is claimed is:

1. A method of performing emergency responder cost recovery, the method comprising:
electronically receiving, from a remote computing device associated with an emergency responder organization, data that includes at least incident data, individual data and insurance data relating to an incident;
automatically generating an incident report based on the received data;
electronically transmitting the incident report to the emergency responder organization;
generating an insurance claim based on the received data; and
electronically transmitting the insurance claim to an insurance carrier.

2. The method of claim 1, wherein, the remote computing device comprises a portable computing device running a software application that prompts a user to enter the incident data, individual data and insurance data, and wherein the entered data includes at least text and pictures.

3. The method of claim 2, wherein the incident is an automobile accident, wherein the individual data comprises driver data, and wherein the pictures include pictures taken using a camera of the portable computing device of the insurance card, a drivers license for at least one the drivers involved in the automobile accident, and a vehicle registration card.

4. The method of claim 3, wherein the received data includes an audio file containing a description of the automobile accident.

5. The method of claim 3, the method further comprising:
receiving payment on the insurance claim;
providing a portion of the received payment to the emergency responder organization.

6. The method of claim 5, further comprising:
providing the remote computing device and the software application to the emergency responder organization without any initial charge; and
recovering a cost of the remote computing device and/or the software application by reducing the portion of the received payment that is provided to the emergency responder organization.

7. The method of claim 2, wherein the received data includes captions for at least some of the pictures included in the received data.

8. The method of claim 1, the method further comprising:
generating a recoverable cost listing; and
automatically combining the incident report and the recoverable cost listing to generate the insurance claim.

9. The method of claim 1, further comprising transmitting insurance claim status information to the emergency responder organization.

10. The method of claim 1, further comprising automatically transmitting a reminder to the emergency responder organization to forward a copy of an accident report.

11. The method of claim 3, wherein the received data further includes data that was collected by scanning a bar code.

12. A method of collecting data at a scene of an accident for use in generating an accident report and an insurance claim, the method comprising:
collecting data relating to the accident at the scene of the accident using a portable computing device that runs a cost recovery software application, the data including:
a description of the accident;
pictures of the accident scene taken using a camera on the portable computing device,
additional pictures taken using the camera on the portable computing device, the additional pictures including pictures of at least one of a driver's license of a driver involved in the accident, a police report relating to the accident, a license plate of a vehicle involved in the accident, a registration card of a vehicle involved in the accident, and an insurance card; and
scanned data obtained by using a scanning capability on the portable computing device to scan a document;
electronically transmitting the collected data to a remote server associated with a third party service provider for use in filing a cost recovery insurance claim; and
electronically receiving an accident report from the third party service provider for use in preparing an official accident report.

13. The method of claim 12, wherein the description of the accident comprises recorded audio data.

14. The method of claim 12, further comprising receiving captions for at least some of the pictures and/or the additional pictures using the software application and the portable computing device.

15. The method of claim 12, further comprising:
deleting the collected data from the portable computing device in response to receiving an indication that the collected data has been successfully transmitted to the third party service provider.

16. The method of claim 12, wherein the collected data includes a picture of a police report relating to the accident or identification of a police department present at the scene of the accident and the name of a police officer present or an identification number associated with the police report relating to the accident.

17. A system for generating incident reports and insurance claims for emergency responder cost recovery, comprising:
a server having a computer readable medium and a processor, the server in electronic communications with a remote computing device, an insurance carrier and an emergency responder organization; and
a set of computer readable instructions stored in the computer readable medium that, when executed by the processor:
receive incident data, individual data and insurance data from the remote computer device;
receive insurance information from an insurance carrier;
generate insurance claims,
generate at least one incident report based on the received incident data, individual data, insurance data and insurance information;
transmit the incident report to the emergency responder organization;
transmit the insurance claim to the insurance carrier;
receive insurance claim status information; and
provide the insurance claim status information to the emergency responder organization.

18. The system of claim 17, wherein the set of computer readable instructions stored in the computer readable medium are further configured to receive cost recovery data from the remote computing device including at least identification of supplies used by the emergency responder organization in responding to the incident and/or equipment damaged during the response to the incident.
